(19) United States
(12) Patent Application Publication
(10) Pub. No.: US 2025/0336059 A1
(43) Pub. Date: Oct. 30, 2025

(54) COMPUTER IMPLEMENTED METHOD FOR THE DETECTION OF DEFECTS IN AN OBJECT COMPRISING INTEGRATED CIRCUIT PATTERNS AND CORRESPONDING COMPUTER PROGRAM PRODUCT, COMPUTER-READABLE MEDIUM AND SYSTEM MAKING USE OF SUCH METHODS

(71) Applicant: Carl Zeiss SMT GmbH, Oberkochen (DE)

(72) Inventors: Anna Alperovich, Neu-Ulm (DE); Alexander Freytag, Erfurt (DE); Bjoern Froehlich, Jena (DE); Bjoern Barz, Jena (DE); Ecaterina Bodnariuc, Berlin (DE)

(21) Appl. No.: 19/260,892

(22) Filed: Jul. 7, 2025

Related U.S. Application Data
(63) Continuation of application No. PCT/EP2024/052007, filed on Jan. 26, 2024.

(30) Foreign Application Priority Data
Feb. 22, 2023 (DE) 102023104378.1

(51) Int. Cl. G06T 7/00; G06T 7/30

(52) U.S. Cl. CPC G06T 7/001; G06T 7/30; G06T 2207/20081; G06T 2207/20084; G06T 2207/30148

(57) ABSTRACT

The invention relates to a computer implemented method for defect detection comprising: obtaining an imaging dataset of an object comprising integrated circuit patterns; obtaining a reference dataset of the object; registering the imaging dataset and the reference dataset by obtaining at least one transformation field pair comprising an input transformation field and a corresponding reference transformation field, wherein the input transformation field or the reference transformation field can be zero; and detecting defects in the imaging dataset using the at least one obtained transformation field pair. The invention also relates to a computer-readable medium, a computer program product and a system for detecting defects.

### CROSS-REFERENCE TO RELATED APPLICATIONS

This application is a continuation of and claims benefit under 35 U.S.C. § 120 from PCT Application No. PCT/EP2024/052007, filed on Jan. 26, 2024, which claims priority from German Application No. 10 2023 104 378.1, filed on Feb. 22, 2023. The entire contents of each of these earlier applications are incorporated herein by reference.

### TECHNICAL FIELD

The invention relates to systems and methods for quality assurance of objects comprising integrated circuit patterns, more specifically to a computer implemented method, a computer-readable medium, a computer program product and a corresponding system for defect detection in an imaging dataset of such an object. By comparing the imaging dataset to a reference dataset of the object defects can be detected. The method, computer-readable medium, computer program product and system can be utilized for quantitative metrology, process monitoring, defect detection and defect review in objects comprising integrated circuit patterns, e.g., in photolithography masks, reticles or wafers.

### BACKGROUND

A wafer made of a thin slice of silicon serves as the substrate for microelectronic devices containing semiconductor structures built in and upon the wafer. The semiconductor structures are constructed layer by layer using repeated processing steps that involve repeated chemical, mechanical, thermal and optical processes. Dimensions, shapes and placements of the semiconductor structures and patterns are subject to several influences. One of the most crucial steps is the photolithography process.

Photolithography is a process used to produce patterns on the substrate. The patterns to be printed on the surface of the substrate are generated by computer-aided-design (CAD). From the design, for each layer a photolithography mask is generated, which contains a magnified image of the computer-generated pattern to be etched into the substrate. The photolithography mask can be further adapted, e.g., by use of optical proximity correction techniques. During the printing process an illuminated image projected from the photolithography mask is focused onto a photoresist thin film formed on the substrate. A semiconductor chip powering mobile phones or tablets comprises, for example, approximately between 80 and 120 patterned layers.

Due to the growing integration density in the semiconductor industry, photolithography masks have to image increasingly smaller structures onto wafers. The aspect ratio and the number of layers of integrated circuits constantly increases and the structures are growing into 3^{rd} (vertical) dimension. The current height of the memory stacks is exceeding a dozen of microns. In contrast, the feature size is becoming smaller. The minimum feature size or critical dimension is below 10 nm, for example 7 nm or 5 nm, and is approaching feature sizes below 3 nm in near future. While the complexity and dimensions of the semiconductor structures are growing into the 3^{rd} dimension, the lateral dimensions of integrated semiconductor structures are becoming smaller. Producing the small structure dimensions imaged onto the wafer requires photolithographic masks or templates for nanoimprint photolithography with ever smaller structures or pattern elements. The production process of photolithographic masks and templates for nanoimprint photolithography is, therefore, becoming increasingly more complex and, as a result, more time-consuming and ultimately also more expensive. With the advent of EUV photolithography scanners, the nature of masks changed from transmission based to reflection-based patterning.

On account of the tiny structure sizes of the pattern elements of photolithographic masks or templates, it is not possible to exclude errors during mask or template production. The resulting defects can, for example, arise from degeneration of photolithography masks or particle contamination. Of the various defects occurring during semiconductor structure manufacturing, photolithography related defects make up nearly half of the number of defects. Hence, in semiconductor process control, photolithography mask inspection, review, and metrology play a crucial role to monitor systematic defects. Defects detected during quality assurance processes can be used for root cause analysis, for example, to modify or repair the photolithography mask. The defects can also serve as feedback to improve the process parameters of the manufacturing process, e.g., exposure time, focus variation, etc.

Photolithography mask inspection needs to be done at multiple points in time in order to improve the quality of the photolithography masks and to maximize their usage cycles. Once the photolithography mask is fabricated according to the requirements, an initial quality assessment of the photolithography mask is done at the mask house before it is shipped to the wafer fab. Semiconductor device design and photolithography mask manufacturing quality are verified by different procedures before the photolithography mask enters a semiconductor fabrication facility to begin production of integrated circuits. The semiconductor device design is checked by software simulation to verify that all features print correctly after photolithography in manufacturing. The photolithography mask is inspected for defects and measured to ensure that the features are within specification. The data gathered during this process becomes the golden baseline or reference for further inspections to be performed at the mask house or wafer fab. Any defects found on the photolithography mask are validated using a review tool followed by a decision of sending the photolithography mask for repair or decommissioning the mask and ordering a new one. At the wafer fab, the photolithography mask is scanned to find additional defects called “adders” compared to the last scan performed at the mask house. Each of these adders is analyzed using a review tool. In case of a particle defect, the particle is removed. In case of a pattern-based defect the photolithography mask is either repaired, if possible, or replaced by a new one. The inspection process is repeated after every few photolithography cycles.

Each defect in the photolithography mask can lead to unwanted behavior of the produced wafer, or a wafer can be significantly damaged. Therefore, each defect must be found and repaired if possible and necessary. Reliable and fast defect detection methods are, therefore, important for photolithography masks.

Apart from defect detection in photolithography masks, defect detection in wafers is also crucial for quality management. During the manufacturing of wafers many defects apart from photolithography mask defects can occur, e.g., during etching or deposition. For example, bridge defects can indicate insufficient etching, line breaks can indicate excessive etching, consistently occurring defects can indicate a defective mask and missing structures hint at non-ideal material deposition etc. Therefore, a quality assurance process and a quality control process is important for ensuring high quality standards of the manufactured wafers.

Apart from quality assurance and quality control, defect detection in wafers is also important during process window qualification (PWQ). This process serves for defining windows for a number of process parameters mainly related to different focus and exposure conditions in order to prevent systematic defects. In each iteration a test wafer is manufactured based on a number of selected process parameters, e.g., exposure time, focus variation, etc., with different dies of the wafer being exposed to different manufacturing conditions. By detecting and analyzing the defects in the different dies based on a quality assurance process, the best manufacturing process parameters can be selected, and a window or range can be established for each process parameter from which the respective process parameter can be selected. In addition, a highly accurate quality control process and device for the metrology of semiconductor structures in wafers is required. The recognized defects can, thus, be used for monitoring the quality of wafers during production or for process window establishment. Reliable and fast defect detection methods are, therefore, important for objects comprising integrated circuit patterns.

An object comprising integrated circuit patterns can refer, for example, to a photolithography mask, a reticle or a wafer. In a photolithography mask or reticle the integrated circuit patterns are mask structures used to generate semiconductor patterns in a wafer during the photolithography process. In a wafer the integrated circuit patterns are semiconductor structures, which are imprinted on the wafer during the photolithography process.

In order to analyze large amounts of data requiring large amounts of measurements to be taken, machine learning methods can be used. Machine learning is a field of artificial intelligence. Machine learning methods generally build a parametric machine learning model based on training data consisting of a large number of samples. After training, the method is able to generalize the knowledge gained from the training data to new previously unencountered samples, thereby making predictions for new data. There are many machine learning methods, e.g., linear regression, k-means, support vector machines, neural networks or deep learning approaches.

Deep learning is a class of machine learning that uses artificial neural networks with numerous hidden layers between the input layer and the output layer. Due to this complex internal structure the networks are able to progressively extract higher-level features from the raw input data. Each level learns to transform its input data into a slightly more abstract and composite representation, thus deriving low and high level knowledge from the training data. The hidden layers can have differing sizes and tasks such as convolutional or pooling layers.

Methods for the automatic detection of defects in objects comprising integrated circuit patterns include defect detection algorithms, which are often based on a die-to-die, die-to-database, or intra-die principle.

The die-to-die principle compares an imaging dataset of portions of an object with a reference dataset of the same portions of another identical object. The discovered deviations are treated as defects. However, this method requires the availability and time-consuming scanning of two corresponding portions of objects and exact knowledge about their relative position. In addition, it fails in case of repeater defects.

An approach similar to the die-to-die principle is the intra-die principle, which compares locations comprising design-identical structures within a single object. Thus, in this case, the reference dataset stems from the same object. This method is only applicable to repetitive structures, e.g., for memory array inspection, and, thus, barely for logical structures.

The die-to-database principle compares an image location of an object with a reference dataset from a database, e.g., a previously recorded image or a simulated image or a CAD file, thereby discovering deviations from the ideal data. Unexpected patterns in the imaging dataset are detected due to large differences. Repeater defects can be handled. However, die-to-database methods are computationally expensive since they require an intermediate registration step to align the imaging dataset to the reference dataset.

For example, the US 2019/0130551 A1 discloses a die-to-database method for defect detection. In a first step, a reference dataset is generated from a number of scan images of a reference wafer, e.g., by a median filter. Imaging datasets are obtained from a target wafer and defects are detected based on pixel value differences of an imaging dataset and the reference dataset. Finally, common defects are excluded by performing a wafer inspection of the target wafer in order to obtain only defects of the photolithography mask. Such approaches, however, require an intermediate alignment step of the reference dataset and the imaging dataset, which is time-consuming and expensive.

It is, therefore, an aspect of the invention to provide an alternative die-to-database defect detection method for objects comprising integrated circuit patterns. It is another aspect of the invention to provide such a method requiring reduced computation time. It is another aspect of the invention to improve the accuracy of die-to-database defect detection methods for objects comprising integrated circuit patterns. It is another aspect of the invention to provide defect detection methods which are applicable to photolithography masks and wafers. It is another aspect of the invention to provide defect detection methods for objects comprising integrated circuit patterns requiring reduced user effort and application time. A further aspect of the invention is to increase the throughput during quality control or quality assurance processes for objects comprising integrated circuit patterns. Another aspect of the invention is to minimize runtimes of quality control.

The aspects are achieved by the invention specified in the independent claims. Advantageous embodiments and further developments of the invention are specified in the dependent claims.

### SUMMARY

Embodiments of the invention concern computer implemented methods, computer-readable media, computer program products and systems implementing defect detection methods for objects comprising integrated circuit patterns.

A first embodiment involves a computer implemented method for defect detection comprising: obtaining an imaging dataset of an object comprising integrated circuit patterns; obtaining a reference dataset of the object; registering the imaging dataset and the reference dataset by obtaining at least one transformation field pair comprising an input transformation field and a corresponding reference transformation field, the input transformation field indicating the transformation of the imaging dataset into a common coordinate system, and the reference transformation field indicating the transformation of the reference dataset into the common coordinate system, wherein the input transformation field or the reference transformation field can be zero; and detecting defects in the imaging dataset using the at least one obtained transformation field pair.

An object comprising integrated circuit patterns refers to a photolithography mask, a reticle or a wafer. In case of a photolithography mask, the photolithography mask may have an aspect ratio of between 1:1 and 1:4, preferably between 1:1 and 1:2, most preferably of 1:1 or 1:2. The photolithography mask may have a nearly rectangular shape. The photolithography mask may be preferably 5 to 7 inches long and wide, most preferably 6 inches long and wide. Alternatively, the photolithography mask may be 5 to 7 inches long and 10 to 14 inches wide, preferably 6 inches long and 12 inches wide.

Throughout this specification, the term “imaging dataset” can refer to images comprising the integrated circuit patterns of the whole object. It can also refer to images of only a subset of the integrated circuit patterns of the object, e.g., to a spatial subset, for example to an area of interest of the object. The imaging dataset can refer to a single image, in particular to an area of interest of a single image. The imaging dataset can refer to two or multiple images, in particular to an area of interest within each of the images. For example, the imaging dataset can comprise several hundred or several thousand or several ten thousand of images. The imaging dataset can be acquired in different ways, e.g., by a charged particle beam system such as a scanning electron microscope (SEM) or a focused ion beam (FIB) microscope or by an atomic force microscope (AFM) or by an aerial image measurement system, e.g., equipped with a staring array sensor or a line-scanning sensor or a time-delayed integration (TDI) sensor.

A reference dataset can comprise an acquired imaging dataset, e.g., of another section of the object or of a different or similar object, in particular of a predominantly defect-free section. A reference dataset can also comprise a simulated dataset, e.g., a CAD file or some kind of model data of the object, e.g., a file comprising geometric structures such as polygons, circles or ellipses indicating the integrated circuit patterns in the object.

The term “defect” refers to a localized deviation of an integrated circuit pattern from an a priori defined norm of the integrated circuit pattern. For instance, a defect of an integrated circuit pattern, e.g., of a semiconductor structure, can result in malfunctioning of an associated semiconductor device. Depending on the detected defect, for example, the photolithography process can be improved, or photolithography masks or wafers can be repaired or discarded. The norm of the integrated circuit pattern can be defined by a corresponding reference object or reference dataset, e.g., a model dataset (e.g., using a CAD design) or an acquired predominantly defect-free dataset.

A transformation field describes the transformation of an imaging dataset or a reference dataset into the common coordinate system. The transformation field can, for example, comprise translation vectors.

By using the at least one obtained transformation field pair for defect detection, the registration step, which is always required for die-to-database methods, can directly be used for defect detection without warping the imaging dataset and/or the reference dataset and comparing them afterwards. In this way, the required computation time is reduced.

In most cases, the common coordinate system corresponds to a coordinate system of the imaging dataset such that the input transformation field is zero and the transformation field pair only contains the reference transformation field, or to a coordinate system of the reference dataset such that the reference transformation field is zero and the transformation field pair only contains the input transformation field. In the special case where the input transformation field is zero, the imaging dataset and the reference dataset are registered by obtaining a single transformation field, the reference transformation field, indicating the transformation of the reference dataset into the coordinate system of the imaging dataset. Similarly, in the special case where the reference transformation field is zero, the imaging dataset and the reference dataset are registered by obtaining a single transformation field, the input transformation field, indicating the transformation of the imaging dataset into the coordinate system of the reference dataset. However, the common coordinate system can also be a different coordinate system, e.g., a coordinate system of an additional imaging dataset, such that the imaging dataset and the reference dataset are registered to the additional imaging dataset in a coordinate system of the additional imaging dataset. In this case, the transformation field pair comprises the input transformation field and the reference transformation field.

Thus, according to a preferred example of the first embodiment of the invention, the common coordinate system corresponds to a coordinate system of the imaging dataset such that the input transformation field of the at least one obtained transformation field pair is zero, or the common coordinate system corresponds to a coordinate system of the reference dataset such that the reference transformation field of the at least one obtained transformation field pair is zero. Since in this case the at least one obtained transformation field pair comprises only an input transformation field or a reference transformation field, the computations are simplified and the runtime of the method is, thus, reduced. In an even more preferred example of the first embodiment of the invention, the common coordinate system corresponds to a coordinate system of the imaging dataset and the input transformation field of the at least one obtained transformation field pair is zero. By registering the reference dataset to the imaging dataset, defects are left unchanged during the registration, thus preserving the information contained in the imaging dataset. In this way, predictions of higher accuracy are obtained.

According to an example of the first embodiment of the invention, the imaging dataset and the reference dataset of the at least one obtained transformation field pair are pre-registered. By pre-registering the imaging dataset and the reference dataset, the imaging dataset and the reference dataset are roughly aligned, so the registration method only needs to consider a limited number of possible transformations. This simplifies the registration task and leads to predictions of higher accuracy.

According to an example of the first embodiment of the invention, at least one transformation field pair is obtained by a registration method comprising a trained machine learning model that maps an input dataset comprising the imaging dataset and the reference dataset to a transformation field pair. Preferably, the machine learning model is trained on training data comprising predominantly defect-free imaging datasets and corresponding reference datasets. The machine learning model can, for example, comprise a deep learning model. By using a machine learning registration method or deep learning model, which learn complex interdependencies automatically from training data, the accuracy of the at least one obtained transformation field pair is improved, and the user effort is reduced.

According to an example of the first embodiment of the invention, at least one transformation field pair is obtained by a registration method solving an optimization problem comprising the difference between the imaging dataset warped according to the input transformation field and the reference dataset warped according to the corresponding reference transformation field of the at least one transformation field pair. By solving optimization problems further assumptions or constraints can be imposed on the at least one transformation field pair, which improves the accuracy of the obtained at least one transformation field pair.

According to an example of the first embodiment of the invention, detecting defects in the imaging dataset comprises measuring the warping error of the imaging dataset warped according to the input transformation field and the reference dataset warped according to the reference transformation field of the at least one obtained transformation field pair. In this way, the accuracy of the defect detection is improved.

According to an aspect of the example of the first embodiment of the invention, detecting defects in the imaging dataset comprises applying a trained machine learning model for defect detection to the warping error. The machine learning model can be trained on training data comprising warping errors of imaging datasets warped according to input transformation fields and corresponding reference datasets warped according to the corresponding reference transformation fields of transformation field pairs and corresponding defect indications. By using a machine learning model for defect detection, the accuracy of the defect detection is improved.

According to an example of the first embodiment of the invention, detecting defects in the imaging dataset comprises measuring a property of spatial subsets of the input transformation field and/or of spatial subsets of the reference transformation field of the at least one obtained transformation field pair. Preferably, one or more thresholds are defined for the measured property. A spatial subset can comprise a single vector, a spatial neighborhood of vectors or a complete input transformation field or reference transformation field. A property of a spatial subset can comprise the length of one or more vectors of the spatial subset, the angle of one or more vectors of the spatial subset with respect to some reference vector, the horizontal or vertical vector component of one or more vectors of the spatial subset, a distance of one or more vectors of the spatial subset from some point, the length of the difference of one or more vectors and some other vector, etc. A property of a spatial subset can also comprise one or more feature vectors generated from the spatial subset, e.g., by applying one or more filters to the spatial subset or by extracting machine learning features from a machine learning model, e.g., a convolutional neural network, when presented with the spatial subset as input. A property of a spatial subset can also comprise a mean value, variance or covariance of any of the properties named before, or a mean value, variance or covariance of one or more vectors of the spatial subset. In this way, defects can be detected in a simple and efficient way directly from the at least one obtained transformation field pair, thereby reducing the runtime of the method.

According to an example of the first embodiment of the invention, detecting defects in the imaging dataset comprises applying a trained machine learning model for defect detection to the at least one obtained transformation field pair. The machine learning model can be trained on training data comprising transformation field pairs and corresponding defect indications. By applying a machine learning model to the at least one obtained transformation field pair, complex interdependencies between the at least one obtained transformation field pair and the corresponding defect indications can be learned automatically from training data. In this way, the accuracy of the method is improved and the effort for the user is reduced, since no thresholds etc. have to be defined.

According to an example of the first embodiment of the invention, detecting defects in the imaging dataset comprises estimating a distribution of spatial subsets of one or more transformation field pairs, wherein defects in the imaging dataset are detected using the at least one obtained transformation field pair and the estimated distribution. In this way, a spatial subset of the at last one obtained transformation field pair, e.g., a single vector or a spatial neighborhood of vectors, can be compared to a distribution estimated from a number of samples of spatial subsets, either from the at least one obtained transformation field pair or from other, preferably predominantly defect-free, transformation field pairs, e.g., from acquired or simulated transformation field pairs. Thus, spatial subsets of the at least one transformation field pair are statistically compared to other spatial subsets of the same or different transformation field pairs. Using the estimated statistical distribution, defects can be detected with higher accuracy.

According to an aspect of the example of the first embodiment of the invention, detecting defects in the imaging dataset comprises estimating a confidence interval or a confidence region of the estimated distribution. In this way, the accuracy of the detected defects is improved.

Instead of computing distributions of spatial subsets of transformation fields, the uncertainty of the registration method can be used to detect defects.

According to an example of the first embodiment of the invention, multiple transformation field pairs registering the imaging dataset and the reference dataset are obtained, and detecting defects in the imaging dataset comprises measuring the variation of the multiple obtained transformation field pairs. In this way, the uncertainty of the registration method can be measured and used as indicator for the presence of a defect.

According to an aspect of the example of the first embodiment of the invention, obtaining each of the multiple transformation field pairs comprises applying a different registration method to the imaging dataset and the reference dataset. By using different registration methods, the uncertainty of the registration methods can be measured and used as a likelihood for the presence of a defect.

According to an aspect of the example of the first embodiment of the invention, obtaining each of the multiple transformation field pairs comprises applying random perturbations to the imaging dataset and/or to the reference dataset and/or to parameters of the registration method. By using random perturbations, the uncertainty of the registration method can be measured and used as a likelihood for the presence of a defect.

According to an aspect of the example of the first embodiment of the invention, obtaining the multiple transformation field pairs comprises using a trained probabilistic generative model. The probabilistic generative model can be trained on predominantly defect-free training data. The probabilistic generative model preferably maps an imaging dataset and a reference dataset to a distribution over potential corresponding transformation field pairs. Samples can be drawn from this distribution to generate the multiple transformation field pairs. For example, the probabilistic generative model is a variational autoencoder or a conditional generative adversarial network.

Using probabilistic generative models, multiple transformation field pairs can be generated. The multiple transformation field pairs can be viewed as possible predominantly defect-free transformation field pairs underlying the input data. The larger the variance of these further transformation field pairs, the less well the input data can be explained by the further transformation field pairs and the more likely a defect is present. The variance of the multiple transformation field pairs can be measured pixel-wise, for spatial subsets or for the whole transformation field pairs. The probabilistic generative model can be applied to different kinds of input data, for example the input data can comprise an imaging dataset and a corresponding reference dataset. Alternatively, the input data can comprise one or more obtained transformation field pairs. The output data of the probabilistic generative model are multiple transformation field pairs.

In an example, obtaining the multiple transformation field pairs comprises using a probabilistic generative image transformation model, which transforms one or more input images to a distribution over output images, wherein the one or more input images and the output images have the same dimension. Probabilistic generative image transformation models are, thus, a special case of probabilistic generative models. For example, the one or more input images can comprise the imaging dataset and the reference dataset, and the distribution over output images comprises a distribution over transformation field pair components. In another example, the one or more input images comprise transformation field pair components of a transformation field, and the distribution over output images comprises a distribution over transformation field pair components.

According to an aspect of the example of the first embodiment of the invention, measuring the variation of the multiple obtained transformation field pairs comprises estimating a distribution of a spatial subset of the multiple obtained transformation field pairs. The variation can be measured for a single spatial subset, for multiple spatial subsets or for all spatial subsets of the multiple obtained transformation field pairs.

In an example, detecting defects in the imaging dataset comprises estimating one or more moments of the estimated distribution, for example the covariance, the variance, the standard deviation or higher order moments e.g., for each vector or for each subset of vectors of the multiple transformation field pairs. In this way, for a given imaging dataset and a corresponding reference dataset, the uncertainty of the registration method with respect to the imaging dataset is used as defect indicator. By using statistics, the accuracy of the defect detection is improved.

In an example, detecting defects in the imaging dataset comprises generating a transformation field pair registering the imaging dataset and the reference dataset (e.g., using a machine learning registration model or a registration method solving an optimization problem), estimating a confidence interval or a confidence region of the estimated distribution and evaluating the likelihood of the corresponding spatial subset of the generated transformation field pair for being an outlier with respect to the estimated distribution. In this way, the explainability of the spatial subset of the generated transformation field pair with respect to the corresponding spatial subset of the multiple obtained transformation field pairs is used as defect indicator. If the spatial subset of the generated transformation field pair is an outlier with respect to the estimated distribution, the spatial subset of the generated transformation field pair can be marked as defect. This process can be carried out for one or more spatial subsets, e.g., for each vector of the generated transformation field pair. By using statistics to obtain defect detections, the accuracy of the defect detection is improved.

According to an example of the first embodiment of the invention, detecting defects in the imaging dataset comprises applying a joint registration and defect detection machine learning model to an input dataset comprising the imaging dataset and the reference dataset, the machine learning model computing a transformation field pair and a defect detection in the imaging dataset, the transformation field pair registering the imaging dataset and the reference dataset. By jointly estimating the transformation field pair and the defect detection, an improved accuracy can be obtained since the machine learning model is trained to optimize both tasks together.

According to an example, a computer implemented method for training a joint registration and defect detection machine learning model for an input dataset comprising an imaging dataset and a reference dataset comprises: obtaining training data comprising imaging datasets, corresponding reference datasets, and corresponding defect indications, in a training data generation step; and training the machine learning model using the obtained training data in a training step.

Alternatively, the machine learning model can be trained on two or more different training datasets.

According to an example, the joint registration and defect detection machine learning model comprises a registration head and a defect detection head, which are trained jointly, in particular using different training datasets.

A head of a machine learning model refers to a task-specific part of the machine learning model that comprises an output layer and optionally one or more hidden layers. Usually, one or more heads are connected to a backbone of the model. The backbone of the model is responsible for extracting features from the input that contain higher level information. Each head uses these features or a subset of these features as input to predict the task-specific outcome. The optimized loss during training is usually a weighted sum of the individual losses for each head.

The registration head is best trained using predominantly defect-free imaging datasets and corresponding reference datasets, whereas the defect detection part is best trained using imaging datasets including defects. Thus, by training the registration head and the defect detection head with different training datasets, class imbalancing can be prevented. Since both heads share a common backbone of the model, they mutually benefit from the information provided by the training data of the other head. In this way, overfitting is prevented. Thus, the accuracy of the registration and defect detection can be improved, and training time can be reduced.

According to an example, a computer implemented method for training a joint registration and defect detection machine learning model for an input dataset comprising an imaging dataset and a reference dataset, the joint registration and defect detection machine learning model comprising a registration head and a defect detection head, comprises: obtaining a registration training dataset comprising predominantly defect-free imaging datasets and corresponding reference datasets; obtaining a defect detection training dataset comprising imaging datasets including defects, corresponding reference datasets and corresponding defect indications; training the registration head of the machine learning model using the registration training dataset; and training the defect detection head of the machine learning model using the defect detection training dataset. By training the registration head and the defect detection head of the machine learning model with separate datasets, negative effects from class imbalancing on model training can be reduced or even prevented. Thus, the accuracy of the predictions of the machine learning model can be improved and the time required for training the machine learning model can be reduced.

The imaging dataset can be acquired in different ways, e.g., by a charged particle beam system such as a scanning electron microscope (SEM) or a focused ion beam (FIB) microscope or by an atomic force microscope (AFM) or by an aerial image measurement system, e.g., equipped with a staring array sensor or a line-scanning sensor or a time-delayed integration (TDI) sensor. According to an example of the first embodiment of the invention, the imaging dataset of the object comprising integrated circuit patterns is obtained by an image acquisition method from the group comprising time-delayed integration, x-ray imaging, scanning electron microscopy, focused ion beam microscopy, atomic force microscopy, aerial imaging.

The methods described herein can be applied to defect detection in photolithography masks as well as in wafers or reticles. Thus, according to an example of the first embodiment of the invention, the object comprising integrated circuit patterns is a photolithography mask, a wafer or a reticle.

According to a second embodiment of the invention, a computer-readable medium has stored thereon a computer program executable by a computing device, the computer program comprising code for executing any of the above-described methods for defect detection.

According to a third embodiment of the invention, a computer program product comprises instructions which, when the program is executed by a computer, cause the computer to carry out any of the above-described methods for defect detection.

According to a fourth embodiment of the invention, a system for detecting defects comprises: an imaging device configured to provide an imaging dataset of an object comprising integrated circuit patterns; one or more processing devices; one or more machine-readable hardware storage devices comprising instructions that are executable by one or more processing devices to perform operations comprising any one of the above-described method for defect detection.

The invention described by examples and embodiments is not limited to the embodiments and examples but can be implemented by those skilled in the art by various combinations or modifications thereof.

### BRIEF DESCRIPTION OF DRAWINGS

FIG. 1 illustrates an exemplary transmission-based photolithography system, e.g., a deep ultraviolet (DUV) photolithography system;

FIG. 2 illustrates an exemplary reflection-based photolithography system, e.g., an extreme ultraviolet (EUV) photolithography system;

FIG. 3 shows an imaging dataset of an object comprising integrated circuit patterns in the form of a photolithography mask comprising a defect;

FIG. 4 shows a flowchart illustrating the steps of a computer implemented method according to the first embodiment of the invention;

FIG. 5 illustrates the registration step of the computer implemented method in FIG. 4 in the general case;

FIG. 6 illustrates the registration step of the computer implemented method in FIG. 4 in a simplified case;

FIG. 7 illustrates the use of registration methods for the detection of defects in objects comprising integrated circuit patterns;

FIG. 8 illustrates the use of registration methods for the detection of defects in objects comprising integrated circuit patterns;

FIG. 9 illustrates different ways to use the at least one obtained transformation field pair to detect defects in the imaging dataset;

FIG. 10 shows a flowchart of a computer implemented method for training a defect detection machine learning model;

FIG. 11 illustrates the concept of a variational autoencoder;

FIG. 12 illustrates the use of probabilistic generative models for the detection of defects in objects comprising integrated circuit patterns;

FIG. 13 illustrates an example architecture of a joint registration and defect detection machine learning model for the detection of defects in objects comprising integrated circuit patterns;

FIG. 14 illustrates the use of a joint registration and defect detection machine learning model for the detection of defects in objects comprising integrated circuit patterns;

FIG. 15 shows a flowchart of a computer implemented method for training a joint registration and defect detection machine learning model for an input dataset comprising an imaging dataset and a reference dataset;

FIG. 16 shows a flowchart of a computer implemented method for training a joint registration and defect detection machine learning model for an input dataset comprising an imaging dataset and a reference dataset; and

FIG. 17 schematically illustrates a system, which can be used for inspecting an object comprising integrated circuit patterns for defects.

### DETAILED DESCRIPTION

In the following, advantageous exemplary embodiments of the invention are described and schematically shown in the figures. Throughout the figures and the description, same reference numbers are used to describe same features or components. Dashed lines indicate optional features.

The methods and systems herein can be used with a variety of photolithography systems, e.g., transmission-based photolithography systems 10 or reflection-based photolithography systems 10′.

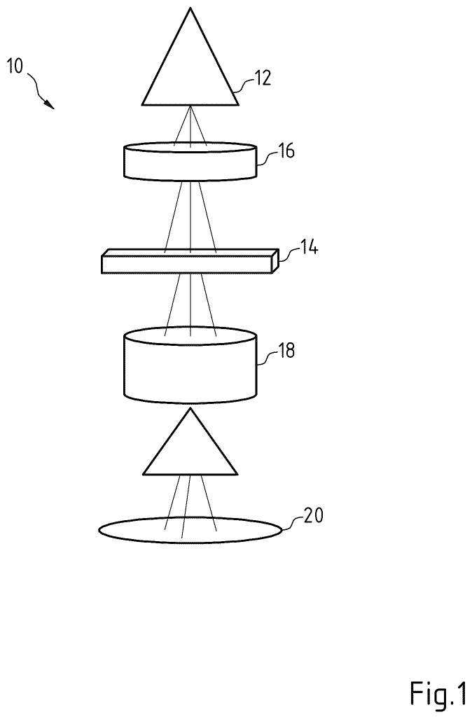

FIG. 1 illustrates an exemplary transmission-based photolithography system 10, e.g., a DUV photolithography system. Major components are a radiation source 12, which may be a deep-ultraviolet (DUV) excimer laser source, imaging optics which, for example, define the partial coherence and which may include optics that shape radiation from the radiation source 12, a photolithography mask 14, illumination optics 16 that illuminate the photolithography mask 14 and projection optics 18 that project an image of the photolithography mask pattern onto a photoresist layer of a wafer 20. An adjustable filter or aperture at the pupil plane of the projection optics 18 may restrict the range of beam angles that impinge on the wafer 20.

In the present document, the terms “radiation” or “beam” are used to encompass all types of electromagnetic radiation, including ultraviolet radiation (e.g., with a wavelength of 365, 248, 193, 157 or 126 nm) and EUV (extreme ultra-violet radiation, e.g., having a wavelength in the range of about 3-100 nm).

Illumination optics 16 may include optical components for shaping, adjusting and/or projecting radiation from the radiation source 12 before the radiation passes the photolithography mask 14. Projection optics 18 may include optical components for shaping, adjusting and/or projecting the radiation after the radiation passes the photolithography mask 14. The illumination optics 16 exclude the light source 12, the projection optics exclude the photolithography mask 14.

Illumination optics 16 and projection optics 18 may comprise various types of optical systems, including refractive optics, reflective optics, apertures and catadioptric optics, for example. Illumination optics 16 and projection optics 18 may also include components operating according to any of these design types for directing, shaping or controlling the projection beam of radiation, collectively or singularly.

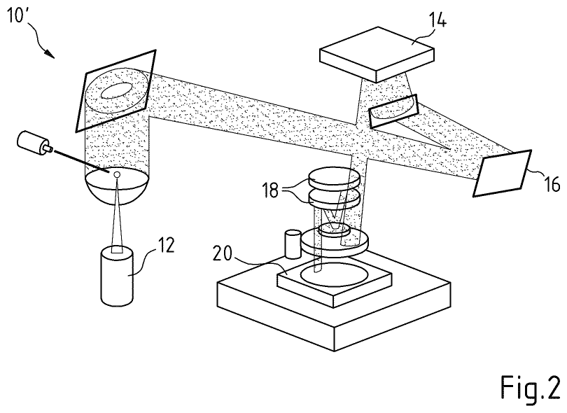

FIG. 2 illustrates an exemplary reflection-based photolithography system 10′, e.g., an extreme ultraviolet light (EUV) lithography system. Major components are a radiation source 12, which may be a laser plasma light source, illumination optics 16 which, for example, define the partial coherence and which may include optics that shape radiation from the radiation source 12, a photolithography mask 14, and projection optics 18 that project an image of the photolithography mask pattern onto a photoresist layer of a wafer 20. An adjustable filter or aperture at the pupil plane of the projection optics 18 may restrict the range of beam angles that impinge on the photoresist layer of the wafer 20.

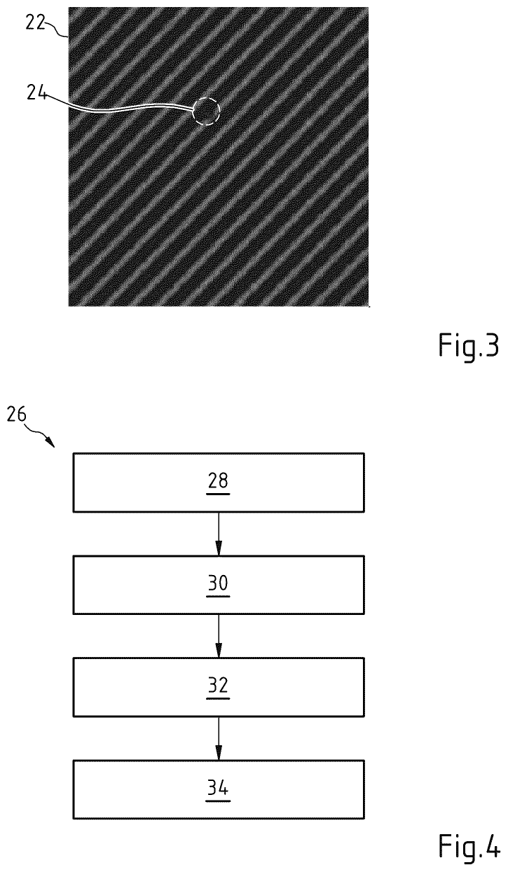

FIG. 3 shows an imaging dataset 22 of an object 98 comprising integrated circuit patterns in the form of a photolithography mask 14 comprising a defect 24. Methods known from the art often use die-to-die or intra-die methods to detect such defects 24. However, the applicability of these methods is limited, and repeater defects cannot be discovered. In addition, they require the availability and time-consuming scanning of two corresponding portions of objects and exact knowledge about their relative position. Die-to-database methods instead allow for the detection of any defect by providing a reference dataset that can be directly compared to an imaging dataset 22 of the object 98 comprising integrated circuit patterns. However, the imaging dataset 22 and the reference dataset must be aligned before the comparison, which is time-consuming. Therefore, it is an aspect of the invention to provide a die-to-database defect detection method for objects 98 comprising integrated circuit patterns with reduced computation time.

An object 98 comprising integrated circuit patterns can refer, for example, to a photolithography mask 14, a reticle or a wafer 20. In a photolithography mask 14 or reticle the integrated circuit patterns can refer to mask structures used to generate semiconductor patterns in a wafer 20 during the photolithography process. In a wafer 20 the integrated circuit patterns can refer to semiconductor structures, which are imprinted on the wafer 20 during the photolithography process.

FIG. 4 shows a flowchart illustrating the steps of a computer implemented method 26 according to the first embodiment of the invention. The computer implemented method 26 for the detection of defects 24 in an imaging dataset 22 of an object 98 comprising integrated circuit patterns comprises: obtaining an imaging dataset 22 of an object 98 comprising integrated circuit patterns in an imaging step 28; obtaining a reference dataset of the object 98 in a reference step 30; registering the imaging dataset 22 and the reference dataset by obtaining at least one transformation field pair comprising an input transformation field and a corresponding reference transformation field, the input transformation field indicating the transformation of the imaging dataset 22 into a common coordinate system, and the reference transformation field 35 indicating the transformation of the reference dataset into the common coordinate system, wherein the input transformation field or the reference transformation field can be zero, in a registration step 32; and detecting defects 24 in the imaging dataset 22 using the at least one transformation field pair in a defect detection step 34.

The imaging dataset 22 can comprise one or more images of one or more portions of the object 98 comprising integrated circuit patterns or of the whole object. According to the techniques described herein, various imaging modalities may be used to acquire the imaging dataset 22 for the detection of defects 24. Along with the various imaging modalities, it would be possible to obtain different imaging data sets 22. Imaging datasets 22 can comprise single-channel images or multi-channel images, e.g., focus stacks. For instance, it would be possible that the imaging dataset 22 includes 2-D images. Here, it would be possible to employ a multi beam scanning electron microscope (mSEM). mSEM employs multiple beams to acquire contemporaneously images in multiple fields of view. For instance, a number of not less than 50 beams could be used or even not less than 90 beams. Each beam covers a separate portion of a surface of the object 98 comprising integrated circuit patterns. Thereby, a large imaging dataset 22 is acquired within a short duration of time. Typically, 4.5 gigapixels are acquired per second. For illustration, one square centimeter of a wafer 20 can be imaged with 2 nm pixel size leading to 25 terapixel of data. Other examples for imaging datasets 22 including 2D images would relate to imaging modalities such as optical imaging, phase-contrast imaging, x-ray imaging, etc. It would also be possible that the imaging dataset is a volumetric 3-D dataset, which can be processed slice-by-slice or as a three-dimensional volume. Here, a crossbeam imaging device including a focused-ion beam (FIB) source, an atomic force microscope (AFM) or a scanning electron microscope (SEM) could be used. Multimodal imaging datasets may be used, e.g., a combination of x-ray imaging and SEM. The imaging dataset 22 can, additionally or alternatively, comprise aerial images acquired by an aerial imaging system. An aerial image is the radiation intensity distribution at substrate level. It can be used to simulate the radiation intensity distribution generated by a photolithography mask 14 during the photolithography process.

The reference dataset 36 of the object 98 comprising integrated circuit patterns can be obtained in different ways. According to an example of the first embodiment of the invention, the reference dataset 36 is obtained by acquiring images of a reference object comprising integrated circuit patterns. The reference object comprising integrated circuit patterns can, for example, be another instance of the same type of object, or it can comprise at least a portion of the integrated circuit patterns of the object 98. According to an example of the first embodiment of the invention, the reference dataset 36 is obtained from one or more portions of the (same) object comprising integrated circuit patterns, e.g., from another die of the object, for example in case of repetitive structures. According to an example of the first embodiment of the invention, the reference dataset 36 is obtained from simulated images of the object 98 comprising integrated circuit patterns, e.g., from CAD files or aerial images. The simulated images can be loaded from a database or a memory or a cloud storage. The reference dataset is preferably predominantly defect-free, comprising none or only few defects (e.g., less than 10%, preferably less than 5% of the reference dataset comprises a defect).

Since the imaging dataset 22 and the reference dataset 36 are not necessarily aligned, the imaging dataset 22 and the reference dataset 36 must be registered before a reasonable comparison between them is possible. Registration is the process of transforming different datasets into one common coordinate system. During the registration process a transformation field is computed for each dataset, the transformation field comprising a transformation vector for each pixel of the dataset. The process of transforming a dataset into the common coordinate system according to the transformation field is called warping. During warping, each pixel of the dataset is transformed according to the corresponding transformation vector in the transformation field. This process typically generates unevenly spaced points, which can be interpolated to obtain the warped dataset in the common coordinate system. Different datasets can then be compared in the common coordinate system 31 by computing the warping error 48, which refers to a pixel-wise difference measure between the warped datasets in the common coordinate system, e.g., between the imaging dataset warped according to the input transformation field and the reference dataset warped according to the reference transformation field.

To simplify computation, either the imaging dataset 22 or the reference dataset 36 can be zero. Thus, according to an example of the first embodiment of the invention, the common coordinate system 31 corresponds to a coordinate system of the imaging dataset 22 such that the input transformation field 33 of the at least one obtained transformation field pair 37 is zero, or the common coordinate system 31 corresponds to a coordinate system of the reference dataset 36 such that the reference transformation field 35 of the at least one obtained transformation field pair 37 is zero. In this case the respective zero transformation field can be ignored in the following such that the at least one obtained transformation field pair 37 only comprises an input transformation field 33 or a reference transformation field 35. In this way, the registration as well as the defect detection is simplified as only one kind of transformation field (input transformation field 33 or reference transformation field 35) must be computed and considered for defect detection. The computation time is, thereby, reduced.

Alternatively, the common coordinate system corresponds to a coordinate system different from the coordinate system of the imaging dataset 22 and different from the coordinate system of the reference dataset such that the input transformation field 33 of the at least one obtained transformation field pair is non-zero and the reference transformation field 35 of the at least one obtained transformation field pair is non-zero.

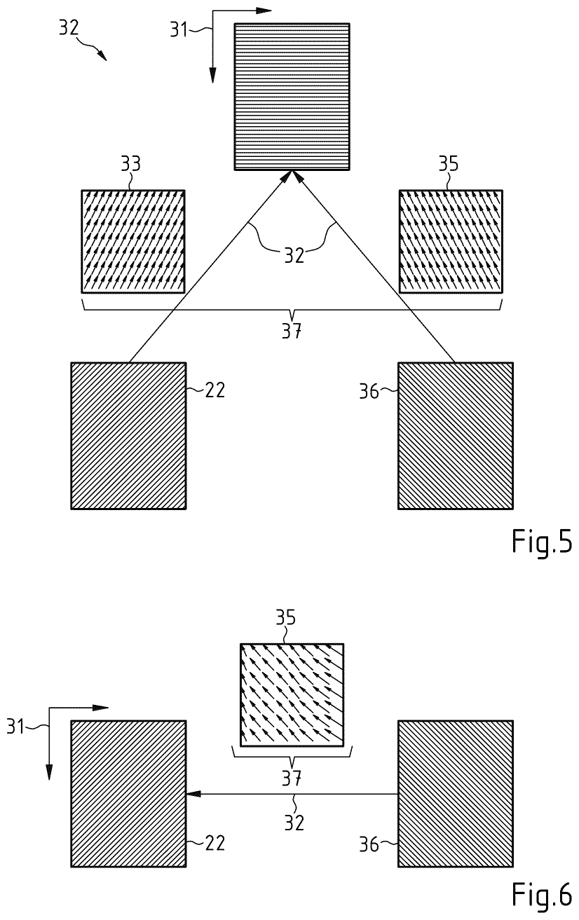

FIG. 5 illustrates the registration step 32 of the computer implemented method in FIG. 4 in the general case. In the general case, the imaging dataset 22 and the reference dataset 36 are both registered into a common coordinate system 31, e.g., given by an additional imaging dataset. The registration process yields at least one transformation field pair 37 comprising the input transformation field 33 and the reference transformation field 35, which are both non-zero.

FIG. 6 illustrates the registration step 32 of the computer implemented method in FIG. 4 in a simplified case. In most cases, the common coordinate system 31 either corresponds to a coordinate system of the imaging dataset 22 as shown here, such that the input transformation field 33 is zero and the at least one obtained transformation field pair 37 only contains the reference transformation field 35, or the common coordinate system 31 corresponds to a coordinate system of the reference dataset 36, such that the reference transformation field 35 is zero and the at least one obtained transformation field pair 37 only contains the input transformation field 33.

According to an example of the first embodiment of the invention, the imaging dataset 22 and the reference dataset 36 of the at least one obtained transformation field pair 37 are pre-registered. Pre-registered means that the imaging dataset 22 and the reference dataset 36 are registered by applying the same first transformation to each of the pixels of the imaging dataset 22 and/or by applying the same second transformation to each of the pixels of the reference dataset 36 in order to roughly align the imaging dataset 22 and the reference dataset 36. Preferably, the first transformation is zero, so the reference dataset 36 is warped to the imaging dataset 22, in order to keep the appearance of the defects 24 in the imaging dataset 22 unchanged. The first and the second transformation can be rigid transformations. A rigid transformation preserves the Euclidean distance between every pair of points. Rigid transformations can include rotations, translations or any sequence of these. By pre-registering the imaging dataset 22 and the reference dataset 36 most parts of the imaging dataset 22 and the reference dataset 36 (except for, e.g., defects 24) are roughly aligned such that the imaging dataset 22 and the reference dataset 36 show roughly the same region of the object 98 comprising integrated circuit patterns. Here roughly means that the displacement between a pixel of the imaging dataset 22 and the corresponding pixel of the reference dataset 36 showing the same location of the object 98 is less than 50 pixels, preferably less than 30 pixels, most preferred less than 10 pixels.

Imaging datasets 22 and reference datasets 36 can be registered in different ways, e.g., by a registration method. Alternatively, an imaging dataset 22 and a reference dataset 36 can be registered by a user indicating a transformation between them.

Registration methods usually solve some kind of optimization problem, which comprises the warping error between the warped imaging dataset 22 and the warped reference dataset 36, wherein the imaging dataset 22 is warped according to the input transformation field 33 of a transformation field pair 37 and the reference dataset 36 is warped according to the reference transformation field 35 of the transformation field pair 37. The optimization problem can comprise further assumptions or constraints, e.g., regularization terms.

For example, the imaging dataset 22 and the reference dataset 36 can be registered using variational calculus. Let I indicate the imaging dataset 22 and R the reference dataset 36, T=(Tₓ, T_{y}) the input transformation field 33 comprising the horizontal input transformation field component Tₓ and the vertical input transformation field component T_{y}, and S=(Sₓ, S_{y}) the reference transformation field 35 comprising the horizontal reference transformation field component Sₓ and the vertical reference transformation field component S_{y}. Here, T and S are not restricted to comprise a horizontal and a vertical transformation field-instead, any two directions forming a basis of R² can be used. Then the optimization problem can be formulated as follows:

$$min {\int }_{Ω} {( I ( x + {T}_{x} ( x , y ) , y + {T}_{y} ( x , y ) ) - R ( x + {S}_{x} ( x , y ) , y + {S}_{y} ( x , y ) ) )}^{2} dxdy + {\vert T \vert}_{TV} + {\vert S \vert}_{TV} .$$

The first term represents the warping error between the imaging dataset 22 and the reference dataset 36. Other error measures can be used instead, e.g., other Lₚ-norms of the difference of the warped imaging dataset 22 and the warped reference dataset 36. Ω represents the set of coordinates of the common coordinate system 31. The TV-norm indicates the total variation norm, which preserves jumps in the transformation fields. Other regularization terms such as an Lₚ norm of the gradient

$${\vert ∇ T \vert}_{{L}_{p}} + {\vert ∇ S \vert}_{{L}_{p}}$$

can be used instead. The optimization problem can be minimized by computing Euler Lagrange Equations (a system of second-order ordinary differential equations) and using iterative schemes known to the person skilled in the art for solving them, thereby obtaining the transformation fields T and S. Further assumptions can be imposed on the transformation fields T and S, e.g., by assuming specific mappings.

For example, the imaging dataset 22 and the reference dataset 36 can be registered by solving an optimization problem comprising the warping error, wherein the input transformation field 33 and/or the reference transformation field 35 are affine linear mappings.

According to an example of the first embodiment of the invention, at least one transformation field pair 37 is obtained by a registration method comprising a trained machine learning model that maps an input dataset comprising the imaging dataset 22 and the reference dataset 36 to a transformation field pair. Preferably, the machine learning model is trained on training data comprising predominantly defect-free imaging datasets 22 and corresponding reference datasets 36. Predominantly defect-free means that less than 10%, preferably less than 5%, of the data of the imaging datasets 22 used for training belongs to a defect. The transformation field pairs 37 of the training data are preferably pre-registered. Thus, the machine learning model only needs to learn small deviations between the imaging dataset 22 and the corresponding reference dataset 36, thereby making the training simpler and more effective and the machine learning model more accurate due to the reduced complexity of the learning task.

Preferably, the machine learning model comprises a deep learning model. Due to their complex internal structure, deep learning models are able to learn complex interrelations between the input and the output of the deep learning model, thereby achieving highly accurate predictions for unknown data samples. For learning transformation field pairs 37 between imaging datasets 22 and reference datasets 36, the architecture of the deep learning model can, for example, be based on a standard U-net architecture with an adapted final output head. In an example, the deep learning model uses a concatenated imaging dataset 22 and corresponding reference dataset 36 as input and maps them to a transformation field pair 37. In another example, the architecture of the deep learning model is based on a standard U-net architecture with separate encoding branches for the imaging dataset 22 and the reference dataset 36, such that the results of the two branches are concatenated and analyzed by a standard U-net. The transformation field pair comprises a horizontal input transformation field component 40, a vertical input transformation field component 42, a horizontal reference transformation field component and a vertical reference transformation field component. If the input transformation field 33 or the reference transformation field 35 is zero, the deep learning model maps the input only to the respective non-zero horizontal and vertical transformation field components. The loss function, which defines the optimization problem to be solved by the deep learning model, can comprise some kind of warping error measuring the difference between the transformed imaging dataset 22 and the transformed reference dataset 36 in the common coordinate system 31, wherein the imaging dataset 22 is transformed by the input transformation field 33 and the reference dataset 36 is transformed by the reference transformation field 35 of the transformation field pair 37 obtained by applying the deep learning model to the input. For example, a mean squared error loss function, a mean absolute error loss function or a Huber loss function can be used. The loss function can comprise further terms, e.g., a segmentation loss based on a number of annotated imaging datasets comprising defects 24, or regularization terms such as the norm of the gradient of the input transformation field 33 and/or the norm of the gradient of the reference transformation field 35 and or the norm of the gradient of the difference between the input transformation field 33 and the reference transformation field 35. For training, a number of around 10,000 imaging datasets 22 of size 512×512 with corresponding reference datasets 36 can be sufficient. After training, the deep learning model is able to register imaging datasets 22 and reference datasets 36.

Since the transformation field pairs 37 indicate pixel-wise transformations between the imaging dataset 22 and the reference dataset 36, misalignments between the reference dataset 36 and the imaging dataset 22 are compensated for by the registration process. Defects 24, however, most of the time cannot be registered in this way, firstly because there usually is no visually similar region close by in the reference dataset 36, and secondly because the registration method restricts the possible transformation field pairs 37. The restriction can be realized, for example, by imposing constraints on the optimization problem or by adding regularization terms as shown above. In case of machine learning models, the possible transformation field pairs 37 are restricted—due to the selection of the training data—to the transformation field pairs 37 learned from predominantly defect-free imaging datasets 22. Thus, defects 24 are visible in the at least one obtained transformation field pair 37 as well as in the warped imaging dataset and/or the warped reference dataset. Defect detection can comprise detecting defects 24 in a pixel-wise manner, that is by assigning a defect likelihood to each pixel, in a spatial subset manner, that is by assigning a defect likelihood to spatial subsets, or defect detection can comprise detecting defects 24 without localizing them, that is by indicating if the imaging dataset 22 contains a defect 24 or not.

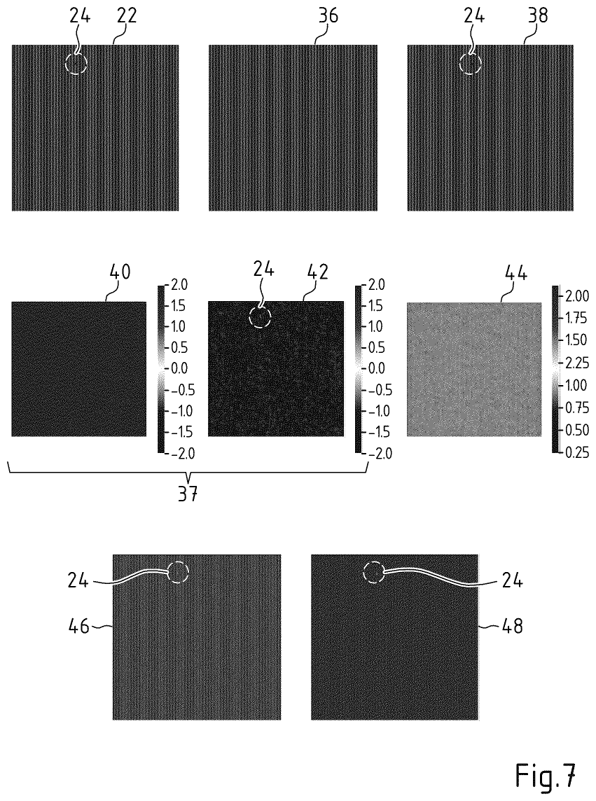

FIG. 7 illustrates the use of registration methods for the detection of defects 24 in objects 98 comprising integrated circuit patterns. The imaging dataset 22 and the reference dataset 36 are pre-registered. The imaging dataset 22 comprising a defect 24 is aligned to the reference dataset 36 by use of a registration method, e.g., a machine learning model or a calculus of variation based optimization model, etc., yielding the input transformation field 33 comprising the horizontal input transformation field component 40 and the vertical input transformation field component 42. In this case the common coordinate system 31 corresponds to the reference dataset coordinate system and, thus, the reference transformation field 35 is zero and can be neglected. Thus, the transformation field pair 37 only comprises the input transformation field 33. The imaging dataset 22 is warped using the input transformation field 33 yielding the warped imaging dataset 38. Due to its size, the defect 24 is slightly visible in the input transformation field 33, in particular in the vertical input transformation field component 42 and in the pixel-wise norm 44 of the input transformation field 33. But the defect 24 is well visible by comparing the warped imaging dataset 38 to the warped reference dataset in the warping error 48. In this case the warped reference dataset corresponds to the reference dataset 36. The difference image 46 of the imaging dataset 22 and the reference dataset 36 without applying any transformations shows the defect 24 together with a lot of deviations due to alignment errors along the edges of the stripes. Instead, by comparing the warped imaging dataset 38 to the reference dataset 36, the warping error 48 also shows the defect 24 but less deviations along the edges of the stripes due to the alignment of the warped imaging dataset 22 and the reference dataset 36.

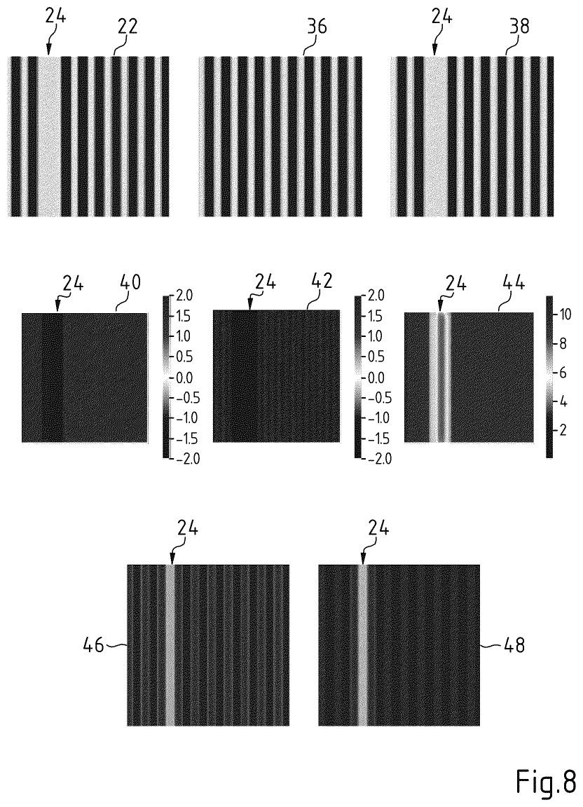

FIG. 8 illustrates the use of registration methods for the detection of defects 24 in objects 98 comprising integrated circuit patterns. The imaging dataset 22 and the reference dataset 36 are pre-registered. The imaging dataset 22 comprising a defect 24 is aligned to the reference dataset 36 by use of a registration method, e.g., a machine learning model or a calculus of variation based optimization model etc., yielding the input transformation field 33 comprising the horizontal input transformation field component 40 and the vertical input transformation field component 42. In this case the common coordinate system 31 corresponds to the reference dataset coordinate system and, thus, the reference transformation field 35 is zero and can be neglected. Thus, the transformation field pair 37 only contains the input transformation field 33. The imaging dataset 22 is warped using the input transformation field 33 yielding the warped imaging dataset 38. Due to its size, the defect 24 is already well visible from the transformation field pair 37 alone comprising the horizontal input transformation field component 40 and the vertical input transformation field component 42. The defect 24 is also well visible by comparing the warped imaging dataset 38 to the warped reference dataset in the warping error 48. In this case the warped reference dataset corresponds to the reference dataset 36. The difference image 46 of the imaging dataset 22 and the reference dataset 36 without applying any transformations shows the defect 24 together with a lot of deviations due to alignment errors along the edges of the stripes. Instead, by comparing the warped imaging dataset 38 to the reference dataset 36, the warping error 48 also shows the defect 24 but less deviations along the edges of the stripes due to the alignment of the warped imaging dataset 22 and the reference dataset 36.

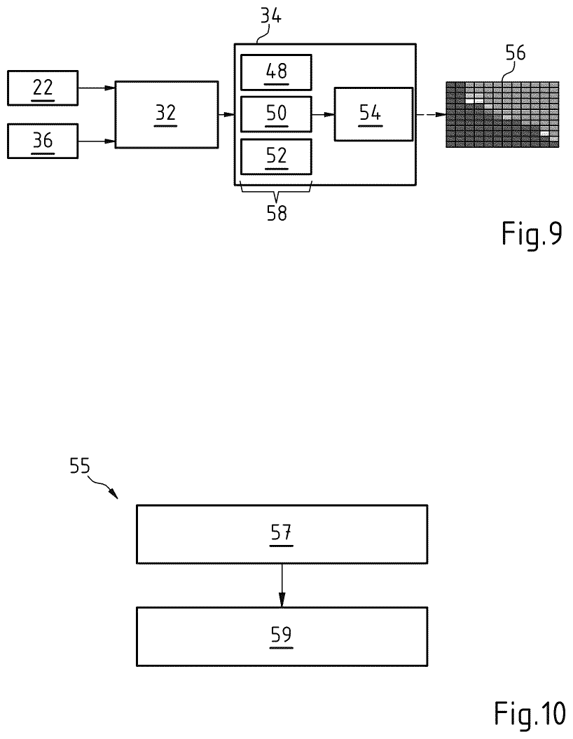

FIG. 9 illustrates different ways to use an obtained transformation field pair 37 to detect defects 24 in the imaging dataset 22. An imaging dataset 22 and a reference dataset 36 are used in the registration step 32 to obtain the transformation field pair 37. In the defect detection step 34 defects 24 can be detected in different ways using the transformation field pair 37. The detected defects 24 can, for example, be indicated in a defect dataset 58. For example, defects 24 can be detected using the transformation field pair 37 directly, e.g., by detecting outliers in the transformation field pair 37, or defects 24 can be detected using the warping error 48, or defects 24 can be detected by applying a machine learning model, e.g., a segmentation algorithm to the transformation field pair 37 and/or the warping error 48. The segmentation algorithm can generate, for example, a segmentation map 50 representing for each pixel in the imaging dataset 22 the likelihood of belonging to a defect 24. The segmentation algorithm can generate, for example, bounding boxes 52 encompassing regions comprising a defect 24. The defect dataset 58 can, thus, comprise a warping error 48, a segmentation map 50, bounding boxes 52, a list of defect coordinates or any other kind of defect indications. Based on the defect dataset 58, defects 24 can be detected, e.g., by analyzing properties of the defect indications in the defect dataset 58, e.g., properties from the group comprising the size of the defect 24, the location of the defect 24 in the imaging dataset 22, the shape of the defect 24, the spatial context of the defect 24, the defect density, the intensity distribution within the defect 24 in the imaging dataset 22, e.g., the mean or variance of the intensity within the defect 24, etc. Finally, detection rates 56 by defect size can optionally be determined. The detection rates 56 indicate, for example, that larger defects 24 are reliably detected whereas smaller defects 24 are detected with less reliability.

In case multiple transformation field pairs 37 are obtained, defects can be detected by fusing the information contained in several or all of them, e.g., by computing the average or maximum warping error for each of the transformation field pairs or by applying a machine learning model for defect detection to each of the transformation field pairs and averaging the result or by applying a machine learning model to the concatenation of several or all of the transformation field pairs 37. For each transformation field pair a different defect detection method can be applied and the resulting defect datasets 58 can, for example, be averaged or the pixel-wise maximum can be used.

According to an example of the first embodiment of the invention, detecting defects 24 in the imaging dataset 22 comprises measuring a property of the vectors of the input transformation field 33 and/or of the vectors of the reference transformation field 35 of the at least one obtained transformation field pair 37. One or more thresholds can be defined for the measured property. For example, the pixel-wise norm 44 of the input transformation field 33 and/or of the reference transformation field 35 can be used as shown in FIGS. 7 and 8. Norm values above a threshold correspond to defects 24. In FIG. 8, a threshold of 5 could, for example, be used. Instead of using a single threshold, local thresholds can be used, or one or more value ranges limited by two thresholds. In addition or alternatively, measuring a property can comprise measuring the angle of the vectors of the input transformation field 33 with respect to some reference vector and/or of the vectors of the reference transformation field 35 with respect to some reference vector.

According to an example of the first embodiment of the invention, detecting defects 24 in the imaging dataset 22 comprises measuring the warping error 48 of the imaging dataset 22 warped according to the input transformation field 33 and the reference dataset 36 warped according to the reference transformation field 35 of the at least one obtained transformation field pair 37. Defects 24 can then be detected by applying a defect detection method to the warping error 48, e.g., by smoothing the warping error 48 and applying one or more thresholds to the warping error 48.

According to an aspect of the example of the first embodiment of the invention, detecting defects 24 in the imaging dataset 22 comprises applying a trained machine learning model for defect detection to the warping error 48. The machine learning model can be trained on training data comprising warping errors 48 of imaging datasets 22 warped according to input transformation fields 33 and corresponding reference datasets 36 warped according to the corresponding reference transformation fields 35 of transformation field pairs 37 and corresponding defect indications.

According to an example of the first embodiment of the invention, detecting defects 24 in the imaging dataset 22 comprises applying a trained machine learning model for defect detection to the at least one obtained transformation field pair 37. The machine learning model can be trained on training data comprising transformation field pairs 37 and corresponding defect indications. The machine learning model for defect detection can additionally use the imaging dataset 22 and/or the reference dataset 36 as input. The machine learning model for defect detection can comprise a segmentation model. The segmentation model can, for example, generate a defect dataset 58 in the form of a segmentation map 50 indicating for each pixel the defect-likelihood or in the form of bounding boxes encompassing the detected defects 24. Defect indications can, for example, comprise segmentation maps, bounding boxes, or lists of coordinates indicating the location of defects 24.

According to an example illustrated in FIG. 10, a computer implemented method 55 for training a machine learning model for defect detection in a transformation field pair 37 comprises: obtaining training data comprising transformation field pairs 37 and corresponding defect indications in a training data generation step 57; training the machine learning model using the obtained training data in a training step 59.

According to an aspect of the example of the first embodiment of the invention, the machine learning model can comprise an autoencoder trained on predominantly defect-free input transformation fields 33 and/or reference transformation fields 35 and/or transformation field pairs 37 and/or differences of input transformation fields 33 and reference transformation fields 35. The input of the autoencoder can comprise a complete input transformation field 33 and/or reference transformation field 35 or a subset of the respective transformation fields.

An autoencoder neural network is a type of artificial neural network used in unsupervised learning to learn efficient representations of unlabeled data. Autoencoders learn the expected statistical variation of defect-free observed input data. An autoencoder comprises two main parts: an encoder that maps the input data into a code, and a decoder that maps the code to a reconstruction of the input data. The encoder neural network and the decoder neural network can be trained to minimize a difference between the reconstructed representation of the input data and the input data itself. The code typically is a representation of the input data with lower dimensionality and can, thus, be viewed as a compressed version of the input data. For this reason, autoencoders are forced to reconstruct the input data approximately, preserving only the most relevant aspects of the input data in the reconstruction.

Therefore, autoencoders can be used for the detection of defects 24. Defects 24 generally concern rare deviations from the norm within an input transformation field 33 or a reference transformation field 35 or a transformation field pair 37 or a difference of an input transformation field 33 and the corresponding reference transformation field 35. Due to the rarity of their occurrence the autoencoder will not reconstruct this kind of information, thus suppressing defects 24 in the reconstruction. Defects 24 can then be detected by comparing the imperfect reconstruction of the input data to the original input data. The larger the difference between a reconstructed transformation vector and the original transformation vector, the more likely the transformation vector belongs to a defect 24. The decision if a defect 24 is present can be taken based on one or more thresholds of the difference of the reconstruction and the input data. Further measurements can also be used for this decision, e.g., the size, location or shape of the differences or their local distribution.

Detecting defects 24 based on the transformation field pair 37 or the warping error 48 can lead to difficulties if a threshold has to be selected for differentiating between defects 24 and non-defects. Therefore, statistical methods are useful and more accurate.

According to an example of the first embodiment of the invention, detecting defects 24 in the imaging dataset 22 comprises estimating a distribution of spatial subsets of one or more transformation field pairs 37, wherein defects 24 in the imaging dataset 22 are detected using the at least one obtained transformation field pair 37 and the estimated distribution. The one or more transformation field pairs 37 can comprise the at least one obtained transformation field pair 37 or other predominantly defect-free transformation field pairs 37, e.g., obtained from reference objects, different objects, by simulation or from CAD files. For example, a distribution of subsets of vectors of the at least one obtained transformation field pair 37 can be estimated from a number of samples thereof, and then defects 24 can be detected in a given subset of vectors of the at least one obtained transformation field pair 37 using the estimated distribution. A spatial subset can comprise a single vector or a spatial region of interest of vectors or all vectors, respectively of the input transformation field 33 and/or the reference transformation field 35 and/or the difference between the input transformation field 33 and the corresponding reference transformation field 35 of the at least one obtained transformation field pair 37. The distribution can be estimated from the vectors themselves or from properties of the vectors, e.g., the angle of the vector with respect to some reference angle or in polar coordinates, the length of the vectors or the horizontal or vertical vector component. The distribution can be estimated from a number of samples of spatial subsets by parametric or non-parametric estimators. A parametric estimator assumes a specific type of distribution, e.g., a Gaussian, and estimates the parameters of the distribution from the samples, e.g., the mean and covariance of the Gaussian. Non-parametric estimators such as the Parzen density estimator do not assume a specific type of distribution but estimate the distribution only from the samples. In theory, for infinitely many samples the Parzen density estimator converges to the true distribution. Thus, non-parametric estimators can be more accurate but require a larger number of samples. The distribution can also be a joint distribution of spatial subsets of the input transformation field 33 and corresponding subsets of the reference transformation field 35, which map to corresponding portions of the warped imaging dataset 38 and the warped reference dataset.

Based on the estimated distribution, outliers can be detected, which indicate the presence of a defect 24. Spatial subsets, which are unlikely with respect to the distribution can be marked as defects 24. In an example, parameters are estimated from the estimated distribution, which are used for defect detection e.g., the mean, variance, covariance, standard deviation or other moments of the distribution, or confidence intervals or confidence regions. For example, the difference of a subset of an obtained transformation field pair 37 and the mean of the distribution, or the Mahalanobis distance of the subset and the mean of the distribution can be used as defect indicators.

According to an aspect of the example of the first embodiment of the invention, detecting defects 24 in the imaging dataset 22 comprises estimating a confidence interval or a confidence region of the estimated distribution. For example, a confidence interval for a quantile q, e.g., 90%, 95% or 97.5%, can be determined for the estimated distribution. In probability theory, a quantile function Q: [0,1]→ [symbol] specifies a confidence interval (for one dimension) or a confidence region (for more than one dimension) of a random variable X such that the probability of the variable X lying outside this confidence interval or confidence range equals the quantile q. Let F_{X}: [symbol] →[0,1] indicate the cumulative distribution function (cdf) of X

$${F}_{X} ( x ) = 𝒫 ( X \leq x ) = q .$$

Then, in the one-dimensional case, the lower and upper quantile functions indicating the lower and upper value of the confidence interval can be expressed as follows:

$${Q}_{lower} ( q ) : = sup \{ x \vert {F}_{X} ( x ) \leq \frac{q}{2} \}$$

$${Q}_{upper} ( q ) : = inf \{ x \vert {F}_{X} ( x ) \geq \frac{q}{2} \}$$

Thus, a sample from the estimated distribution lies outside the confidence interval given by the lower and upper quantile functions with a likelihood of q. For example, for a Gaussian distribution with the mean value u and the standard deviation σ the confidence interval for the confidence level q=99.7% is [μ−3σ; μ+3σ].

For multidimensional distributions, confidence regions can be used, which are a generalization of confidence intervals to higher dimensional spaces. For example, a two-dimensional Gaussian distribution has a confidence region in the form of an ellipse, which can be obtained by computing the eigenvectors and eigenvalues of the estimated covariance matrix.

Based on a confidence interval or confidence region, a defect 24 can be detected in a given subset of a transformation field pair 37 if the subset lies outside the confidence interval or confidence region, respectively, for a pre-defined confidence level q.

By assuming independence between the horizontal and vertical vector components, confidence intervals can also be defined for each vector dimension separately.

According to an aspect of the example of the first embodiment of the invention, detecting defects 24 in the imaging dataset 22 comprises computing p-values of the cumulative distribution function of the estimated distribution. A p-value indicates the probability of observing a value of a random variable X at least as extreme as a given value x of the random variable X under the null-hypothesis that the random variable X is distributed according to the estimated distribution:

$$p = 2 min \{ 𝒫 ( X \geq x \vert {H}_{0} ) , 𝒫 ( X \leq x \vert {H}_{0} ) \}$$

A very small p-value means that such an extreme observed outcome x would be very unlikely under the null-hypothesis that the random variable X is actually distributed according to the estimated distribution. Therefore, a small p-value indicates a high defect-likelihood. The p-values can be directly used to indicate the likelihood for a defect 24, or any function of the p-values. The cdf can be estimated empirically from the samples. Instead of estimating statistics of spatial subsets of the at least one obtained transformation field pair 37, the uncertainty of the registration method can be used as a measure for the presence of a defect 24.

According to an example of the first embodiment of the invention, multiple transformation field pairs registering the imaging dataset 22 and the reference dataset 36 are obtained and detecting defects 24 in the imaging dataset 22 comprises measuring the variation of the multiple obtained transformation field pairs 37. By measuring the variation of different transformation field pairs 37 registering the imaging dataset 22 and the reference dataset 36 uncertainty maps can be generated which indicate the uncertainty of the registration method. Since defects 24 usually correspond to uncommon transformation field pair vectors, the registration method is usually uncertain about the correct transformation. The higher the uncertainty the more likely is a defect 24. There are different ways of obtaining the multiple transformation field pairs registering the imaging dataset 22 and the reference dataset 36, which can be applied separately or together.

According to an aspect of the example of the first embodiment of the invention, obtaining each of the multiple transformation field pairs comprises applying a different registration method to the imaging dataset 22 and the reference dataset 36. Registration methods differ if they optimize a different optimization problem, if they use different mathematical methods for the optimization or if they differ in at least one parameter that influences the output of the registration method. For example, a machine learning registration method differs from a variational calculus based registration method or from a stochastic registration method. For example, a machine learning model differs from another machine learning model if at least one hyperparameter (a parameter used to control the learning process, which is not learned from training data) is different, e.g., the structure of the underlying model (e.g., the number of neurons, the number, size or type of the layers, the filter size, the kernel size of convolutional layers etc.), the training data, the transfer function or the output function of the neurons, the optimization algorithm, etc. A machine learning model also differs from another machine learning model if at least one parameter of the machine learning model is different that is optimized during training, e.g., a weight of a neuron, etc. In an example, different registration methods are applied to the imaging dataset 22 by using autoencoders with dropout during inference. Dropout means that randomly selected weights are set to 0. In this way, differing machine learning models for registration can be used to generate the further transformation fields. Alternatively, an ensemble of autoencoders can be used to obtain the further transformation fields.

According to an aspect of the example of the first embodiment of the invention, obtaining each of the multiple transformation field pairs 37 comprises applying random perturbations to the imaging dataset 22 and/or to the reference dataset 36 and/or to parameters of the registration method. For defect-free regions small perturbations will not change the prediction of the registration method. However, for defects 24 small perturbations may lead to strongly differing predictions due to the uncertainty of the registration method in these locations.

According to an aspect of the example of the first embodiment of the invention, obtaining the multiple transformation field pairs 37 comprises using a trained probabilistic generative model. The probabilistic generative model is preferably trained on predominantly defect-free training data.

A probabilistic generative model describes how a dataset is generated in terms of a probabilistic model. By sampling from this probabilistic model, new data can be generated. Applied to the estimation of transformation field pairs 37, there is some unknown probabilistic model that explains why some transformation field pairs 37 are likely and others are not. The objective of a probabilistic generative model is to model the probabilistic distribution as closely as possible based on predominantly defect-free training data and then sample from the model to generate new, distinctive observations that look as if they could have been included in the training data. In an example, the probabilistic generative model is a variational autoencoder (VAE) or a conditional generative adversarial network (cGAN).

Mathematically, a probabilistic generative model is a statistical model of the joint probability distribution [symbol] (X, Z) on the observable variable X and the latent variable Z. According to Bayes rule it holds for the joint probability

$$𝒫 ( X , Z ) = 𝒫 ( X \vert Z ) 𝒫 ( Z ) .$$

Thus, to generate a data sample x from the probabilistic model, a latent representation z is first sampled from the prior distribution [symbol] (Z), and then the data sample x is sampled from the conditional distribution [symbol] (X|Z=z).

To analyze the uncertainty of the probabilistic model, the latent posterior distribution [symbol] (Z|X) is of interest. Given an observation x, it defines a distribution over the latent variable space indicating the likelihood for each latent variable vector z to explain the observation x. By sampling from this distribution, a number of underlying latent variable vectors z are obtained, which explain the observation x. Thus, if the sampled latent variable vectors strongly differ, the probabilistic model is uncertain about how to explain the observation x. In contrast, if the sampled latent variable vectors are similar, the probabilistic model is more or less certain about how to explain the observation x. By measuring this uncertainty, defects can be detected.

According to Bayes the following holds:

$$𝒫 ( Z \vert X ) = \frac{𝒫 ( X , Z )}{𝒫 ( X )} .$$

However, obtaining the posterior conditional distribution is most of the time intractable since the marginal distribution [symbol] (X) is intractable.

Therefore, probabilistic generative models find approximations to the posterior probability in different ways by choosing and optimizing a parametric model, which is close to the underlying posterior distribution p_{θ}(Z|X)≈ [symbol] (Z|X), where θ is a set of parameters used to describe the parametric model.

An example of a probabilistic generative model can be a probabilistic generative image transformation model. A probabilistic generative image transformation model transforms one or more input images to a distribution over output images, wherein the one or more input images and the output images have the same dimension. The output images can be of the same type as the input images, for example if a horizontal and a vertical transformation field component are transformed into another horizontal and vertical transformation field component, or the output images can be of a different type, for example if an image is transformed into a horizontal and a vertical transformation field component. Two images are of the same type if the image values have the same meaning and are, thus, comparable, e.g., an intensity with respect to a specific image acquisition method, or a vector component, etc.

A special case of a probabilistic generative image transformation model, where the input images are of the same type as the output images, is a variational autoencoder (VAE) as described in the journal article “An introduction to variational autoencoders” by D. Kingma and M. Welling, Foundations and Trends in Machine Learning, Vol. 12, No. 4, pp. 307-372, 2019. The entire content of the aforementioned article is herein incorporated by reference, and its disclosure content is included in the description of this invention. Variational autoencoders (VAEs) represent the encoder and the decoder in a probabilistic way. The probabilistic decoder 68 is defined as p_{θ}(x|z), and the probabilistic encoder 64 is defined as q_{ϕ}(z|x).

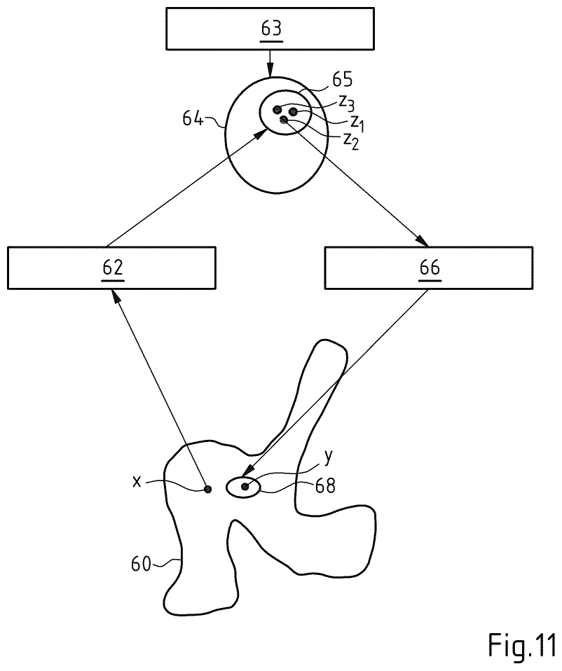

FIG. 11 illustrates the concept of a variational autoencoder. A VAE learns stochastic mappings between the observation space 60, whose empirical distribution is typically complicated, and a latent space 64, whose distribution can be relatively simple. The probabilistic generative model learns a joint distribution p_{θ}(X, Z) that can be factorized as p_{θ}(X,Z)=p_{θ}(X|Z) p_{θ}(Z), with a prior distribution 63 p_{θ}(Z) over the latent space 64, and a stochastic decoder 66 p_{θ}(X|Z) approximating the observation posterior distribution 68. The stochastic encoder 62 q_{ϕ}(Z|X) approximates the true but intractable latent posterior distribution 65 p_{θ}(Z|X) of the probabilistic generative model.

Assumptions can be made for the prior distribution 63 p_{θ}(Z), e.g., a standard normal distribution [symbol] (0, Id), where Id denotes the identity matrix, and for the observation posterior distribution 68 p_{θ}(X|Z), e.g., a normal distribution [symbol] (ƒ(z), c·Id), where f is a function indicating the mean of the Gaussian distribution given an observation z, and c is a constant. The function f can be selected such that, for a given input x, the probability to have y=x when z is sampled from the latent posterior distribution 65 q_{ϕ}(Z|X=x) and then y is sampled from the observation posterior distribution p_{θ}(X|Z=z) is maximized. The latent posterior distribution q (Z|X) is approximated using variational inference methods, wherein the Kullback-Leibler divergence of the true posterior distribution 66 p_{θ}(Z|X) and the approximation q_{ϕ}(Z|X) is minimized.

In practice, the encoder distributions q (Z|X) are often chosen to be normal so that the encoder 62 can be trained to return the mean and the covariance matrix that describe these Gaussians. Thus, the loss function that is minimized when training a VAE is composed of a “reconstruction term” (on the final layer), that tends to make the encoding-decoding scheme as performant as possible, and a “regularization term” (on the latent layer), that tends to regularize the organization of the latent space 64 by making the distributions returned by the encoder 62 close to a standard normal distribution. The regularization term is expressed as the Kullback-Leibler divergence between the returned distribution and a standard Gaussian.

Uncertainty maps based on VAEs can be computed for a given observation x in the observation space 60 as illustrated in FIG. 11: for a given observation x in observation space 60, the stochastic encoder 62 can be used to generate the latent posterior distribution 65 q_{ϕ}(Z|X=x) in the latent space 64. From the latent posterior distribution 65 samples z₁, . . . , zₙ are drawn. The stochastic decoder 66 can then be used to generate an observation posterior distribution 68 in observation space 60 p_{θ}(X|Z=zᵢ), i∈{1, . . . , n} for each of the drawn samples.

Applied to registration, a VAE for registration can be trained using predominantly defect-free transformation field pairs 37. The observation x corresponds to an obtained transformation field pair 37 comprising the input transformation field 33 and the reference transformation field 35. Then multiple transformation field pairs are generated using the obtained transformation field pair 37. First, samples z₁, . . . , zₙ are drawn from the latent posterior distribution 65 q_{ϕ}(Z|X=x) of the VAE, the encoder. Then, for each sample z₁ an observation posterior distribution 68 p_{θ}(X|Z=zᵢ), the decoder, is computed. Based on the resulting observation posterior distributions 68, there are different ways to estimate the uncertainty of the obtained transformation field pair x as will be described below.

In general, however, the type of the input images can differ from the type of the output images of a probabilistic generative image transformation model. For example, the input images can comprise an imaging dataset 22 and a corresponding reference dataset 36, and the output images can comprise horizontal and vertical components of transformation field pairs 37 registering the imaging dataset 22 to the corresponding reference dataset 36. As the type is different for input images and output images, VAEs are not applicable.

Therefore, according to an aspect of the example of the first embodiment of the invention, obtaining the multiple transformation field pairs comprises using a probabilistic generative image transformation model, which transforms one or more input images to a distribution over output images, wherein the one or more input images and the output images have the same dimension, the probabilistic generative image transformation model being trained on predominantly defect-free imaging datasets 22 and corresponding reference datasets 36. Thus, a probabilistic generative image transformation model does not aim at reconstructing the input data but at transforming one or more images to a distribution over images. The architecture of the probabilistic generative image transformation model can be identical to a VAE with the only exception that the input data and the output data are not restricted to be of the same type. Therefore, the above-said for VAEs also applies to probabilistic generative image transformation models with the exception that 1) the observation space is different from the observation posterior distribution space, and 2) the loss function does not contain a reconstruction error as for VAEs but a registration error, e.g., a warping error 48, in addition to the Kullback-Leibler divergence. A probabilistic generative image transformation model can, for example, have a U-net architecture. The U-net can use the imaging dataset 22 and the reference dataset 36 as input data and generate a distribution over transformation field pairs 37 as output data.

A probabilistic generative image transformation model for registration can be trained using predominantly defect-free imaging datasets 22 and corresponding reference datasets 36 and a computational loss function comprising the warping error 48 and the Kullback-Leibler divergence. The observation x corresponds to the obtained imaging dataset 22 and the obtained reference dataset 36. Then the multiple transformation field pairs 37 are obtained using the obtained imaging dataset 22 and the obtained reference dataset 36. First, samples z₁, . . . , zₙ are drawn from the latent posterior distribution 65 of the probabilistic generative image transformation model, the encoder. Then, for each sample zᵢ an observation posterior distribution 68, the decoder, is computed. Based on the resulting observation posterior distributions 68, there are different ways to estimate the uncertainty of the registration method using the multiple obtained transformation field pairs 37.

In an example, based on the observation posterior distributions 68 a number of observations y₁, . . . , yₙ can be generated in the observation posterior distribution space. The observations y₁, . . . , yₙ then correspond to the multiple obtained transformation field pairs. For example, the expectation value can be computed from each observation posterior distribution 68. If the observation posterior distributions 68 are, for example, Gaussians as shown above, the expectation value corresponds to the mean value of each Gaussian distribution ƒ(z). Alternatively, observations y₁, . . . , yₙ can be sampled from the observation posterior distributions 68. In an example, based on the generated observations y₁, . . . , yₙ an uncertainty map can be computed by measuring the variation of these observations. If the variation is small the uncertainty is small and the defect-likelihood is small, if the variation is large the uncertainty is large and the defect-likelihood is large.

In an example, a function of the variance of the observation posterior distributions 68 can be used as an indicator of uncertainty. E.g., the mean variance or the maximum variance of the generated observation posterior distributions 68 can be used to measure uncertainty.

In case a VAE is used, the likelihood of observing x, a specific transformation field pair, given each of the observation posterior distributions 68 can be used as an indicator of uncertainty. Ideally, the likelihood for observing x given the observation posterior distributions 68 should be high meaning that x can be well explained by the probabilistic model. However, if the likelihood of observing x given the observation posterior distributions 68 is low, x cannot be explained by the probabilistic model and probably contains a defect 24. For example, the likelihood of p_{θ}(X=x|Z=z) when z is sampled from the latent posterior distribution 65 q_{ϕ}(Z|X) can be used. Alternatively, a confidence interval can be computed from each of the observation posterior distributions 68 p_{θ}(X|Z=z) and the uncertainty can be measured depending on the number of confidence intervals for which the observation x does not lie inside the confidence interval. Alternatively, p-values can be computed from the observation posterior distributions p_{θ}(X|Z=z) for the observation x. The smaller the p-value is the less likely is x a sample from the corresponding observation posterior distribution and the higher is the uncertainty. The uncertainty can be measured as a function of the p-values, e.g., the mean or maximum p-value, etc.

According to any of these examples, the uncertainty can be measured for the whole observation x, for some dimensions of x or for each dimension of x separately. For example, if the observation posterior distributions 68 are Gaussians with a diagonal covariance matrix, the dimensions of the observations are independent. Thus, the observation posterior distributions 68 as well as the confidence intervals or p-values can be estimated for each dimension separately. In this way, the uncertainty maps can be obtained as functions of the uncertainty for each dimension of the observations.

Further probabilistic generative image transformation models can be used for registration, for example, conditional generative adversarial networks (cGAN), normalizing flow networks, invertible neural networks or diffusion models.

Generative adversarial networks (GANs) rely on a generator that learns to generate new images, and a discriminator that learns to distinguish synthetic images from real images. The generator and the discriminator contest with each other in the form of a zero-sum-game, where one agent's gain is the other agent's loss. Given a training dataset, a GAN learns to generate new data samples with the same statistics as the training dataset.

In conditional generative adversarial networks (cGANs), a conditional setting is applied, meaning that both the generator and discriminator are conditioned on some sort of auxiliary information such as the obtained transformation field pair 37. As a result, the cGAN can learn multi-modal mappings from inputs to outputs by being fed with different contextual information.

Diffusion models, also known as diffusion probabilistic models, are a class of latent variable models motivated by non-equilibrium thermodynamics. They are Markov chains trained using variational inference. The goal of diffusion models is to learn the latent structure of a dataset by modeling the way in which data points diffuse through the latent space.

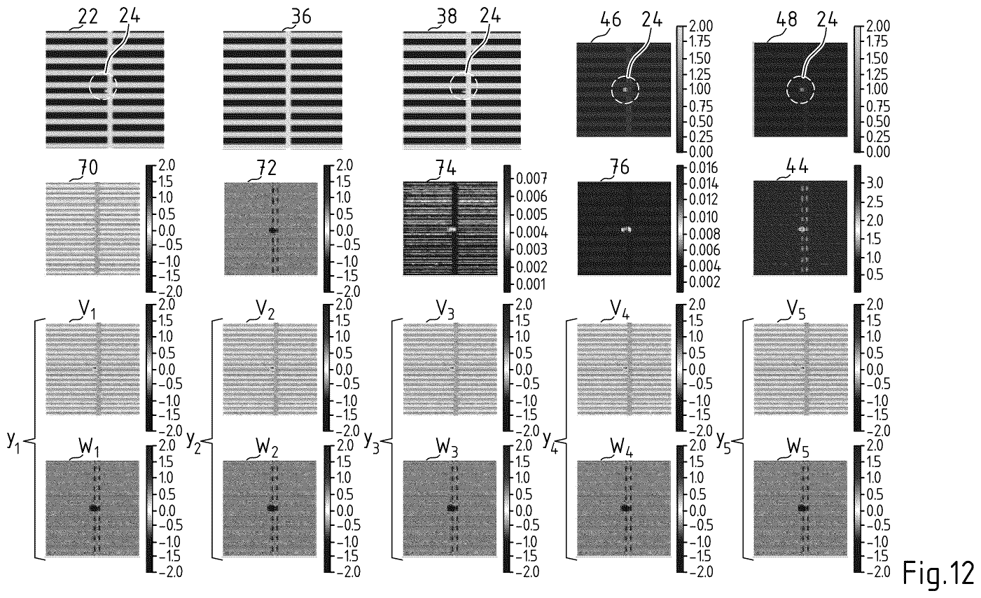

FIG. 12 illustrates the use of a probabilistic generative image transformation model, for the detection of defects 24 in objects 98 comprising integrated circuit patterns. The imaging dataset 22 and the reference dataset 36 are pre-registered. Using the probabilistic generative image transformation model, multiple transformation field pairs y₁, . . . , yₙ are generated as described above. The transformation field pairs y; each comprise an input transformation field 33 comprising a horizontal input transformation field component vᵢ and a vertical input transformation field component wᵢ. The reference transformation field 35 of each of the generated transformation field pairs 37 is zero and can be neglected. From the transformation field pairs yᵢ the mean minimum squared error (MMSE) estimate comprising the horizontal MMSE estimate 70 and the vertical MMSE estimate 72 is computed. The horizontal MMSE estimate 70 is obtained by averaging the horizontal input transformation field components vᵢ, and the vertical MMSE estimate 72 is obtained by averaging the vertical input transformation field components wᵢ. The imaging dataset 22 comprising a defect 24 is aligned to the reference dataset 36 by use of the MMSE estimate. In this case the common coordinate system 31 corresponds to the reference dataset coordinate system and, thus, the reference transformation field 35 is zero and can be neglected while the MMSE estimate corresponds to the input transformation field 33. The imaging dataset 22 is warped using the input transformation field 33 yielding the warped imaging dataset 38. The defect 24 is already visible by comparing the warped imaging dataset 38 to the warped reference dataset in the warping error 48. In this case the warped reference dataset corresponds to the reference dataset 36. The difference image 46 of the imaging dataset 22 and the reference dataset 36 without applying any transformations shows the defect 24 together with a lot of deviations due to alignment errors along the edges of the stripes. Instead, by comparing the warped imaging dataset 38 to the reference dataset 36, the warping error 48 also shows the defect 24 but less deviations along the edges of the stripes due to the alignment of the warped imaging dataset 22 and the reference dataset 36. Using the probabilistic generative image transformation model, e.g., a trained VAE or cGAN, the defect 24 can be detected with higher accuracy.

The samples y₁, . . . , yₙ correspond to transformation field pairs generated by the probabilistic generative image transformation model. Using these multiple obtained transformation field pairs y₁, . . . , yₙ uncertainty maps can be generated by measuring their variation.

Thus, according to an aspect of the example of the first embodiment of the invention, measuring the variation of the multiple obtained transformation field pairs 37 comprises estimating a distribution of a spatial subset of the multiple obtained transformation field pairs 37. Such a distribution can be estimated for a single spatial subset, for multiple spatial subsets or for all spatial subsets of the multiple obtained transformation field pairs, e.g., for each vector.

The estimated distribution can be used in different ways.

In an example, detecting defects 24 in the imaging dataset 22 comprises estimating one or more moments of the estimated distribution, e.g., a covariance, a variance, a standard deviation or higher order moments. In this way, the uncertainty of the registration method for a given imaging dataset 22 and a corresponding reference dataset 36 can be measured. The larger the moment of the distribution the more likely a defect 24 is present within the spatial subset. In this way, the accuracy of the defect detection can be improved.

Based on the multiple obtained transformation field pairs, for example, the minimum mean squared error (MMSE) estimate or the standard deviation can be computed. FIG. 12 shows the horizontal MMSE estimate 70 and the vertical MMSE estimate 72 as well as the horizontal standard deviation 74 and the vertical standard deviation 76 for the multiple obtained transformation field pairs y₁, . . . , y₅, each comprising the indicated horizontal and vertical component (vᵢ, wᵢ) of the corresponding input transformation field 33. The standard deviation can be used as uncertainty map.

In another example, detecting defects 24 in the imaging dataset 22 comprises generating a transformation field pair registering the imaging dataset 22 and the reference dataset 36, estimating a confidence interval or a confidence region of the estimated distribution and evaluating the likelihood of the corresponding spatial subset of the generated transformation field pair for being an outlier with respect to the estimated distribution. In this way, the explainability of the spatial subset of the generated transformation field pair by the corresponding spatial subsets of the obtained multiple transformation field pairs underlying the distribution can be measured. For example, for each vector of the generated transformation field pair a distribution of this vector over the multiple obtained transformation fields is estimated and a confidence interval for each distribution is estimated. If the spatial subset of the generated transformation field pair lies outside the confidence interval or confidence region, it cannot be explained by the distribution, which was estimated from predominantly defect-free training data. Therefore, the likelihood for a defect within the spatial subset of the generated transformation field pair is high. In this way, the accuracy of the defect detection can be improved.

In another example, detecting defects 24 in the imaging dataset 22 comprises generating a transformation field pair registering the imaging dataset 22 and the reference dataset 36 and computing p-values of the cumulative distribution function of the estimated distribution. A small p-value indicates a high defect-likelihood. The p-values can be directly used to indicate the likelihood for a defect 24, or any function of the p-values. In this way, the accuracy of the defect detection can be improved.

A spatial subset can comprise a single vector or a spatial region of interest of vectors or all vectors, respectively of the input transformation field 33 and/or the reference transformation field 35 of the transformation field pair 37. The distribution can be estimated from the vectors themselves or from properties of the vectors, e.g., the angle of the vector with respect to some reference angle or in polar coordinates, the length of the vectors or the horizontal or vertical vector component. The distribution can be estimated from a number of samples of spatial subsets by parametric or non-parametric estimators. The distribution can also be a joint distribution of spatial subsets of the input transformation field 33 and corresponding subsets of the reference transformation field, which map to corresponding portions of the warped imaging dataset 38 and the warped reference dataset.

The different methods for detecting defects 24 in the imaging dataset 22 described above can be used separately, or two or more of them can be combined in a defect detection method.

Instead of separating the registration task and the defect detection task, both tasks can be combined into one joint approach.

According to an example of the first embodiment of the invention, detecting defects 24 in the imaging dataset 22 comprises applying a joint registration and defect detection machine learning model to an input dataset comprising the imaging dataset 22 and the reference dataset 36, the machine learning model computing a transformation field pair 37 and a defect detection in the imaging dataset 22, the transformation field pair 37 registering the imaging dataset 22 and the reference dataset 36. The machine learning model is, thus, trained for the joint estimation of a transformation field pair 37 and defect detections in input datasets.

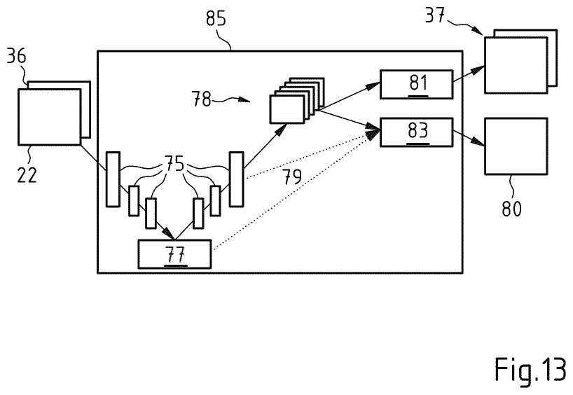

FIG. 13 illustrates an example architecture of a joint registration and defect detection machine learning model 85 for the detection of defects 24 in objects 98 comprising integrated circuit patterns. The input of the joint registration and defect detection machine learning model 85 is an imaging dataset 22 and a corresponding reference dataset 36, which are mapped to the output comprising a transformation field pair 37 and a defect detection map 80 indicating the detected defects 24 in the imaging dataset 22. The architecture of the joint registration and defect detection machine learning model 85 comprises an autoencoder structure including an encoder part and a decoder part with a number of layers 75 and a bottleneck 77. The encoder part maps the input data to a code, which is a representation of the input data with lower dimensionality and can, thus, be viewed as a compressed version of the input data. Instead of mapping the code to a reconstruction of the input (as is usually the case for an autoencoder) the decoder part maps the code to a number of features 78, for example 16 feature maps with half of the spatial resolution of the imaging dataset 22 and the reference dataset 36. The features 78 are the input to a registration head 81 and a defect detection head 83. The registration head 81 and the defect detection head 83 can comprise a single output layer and optionally a number of hidden layers. The registration head 81 maps the features 78 to a transformation field pair 37, whereas the defect detection head 83 maps the same features 78 to a defect detection map 80. By using the same features 78 for the registration head 81 and the defect detection head 83 overfitting is prevented. The defect detection head 83 can, alternatively, be connected to any of the previous layers 75 of the decoder part or to the bottleneck as indicated by the arrows 79. Alternatively, the defect detection head 83 can be connected to the registration head 81 in a sequential fashion such that the output of the registration head 81, the transformation field pair 37, serves as input of the defect detection head 83. Instead of using an architecture corresponding to an autoencoder, an architecture corresponding to a variational autoencoder can also be used. In this way, an improved accuracy can be obtained.

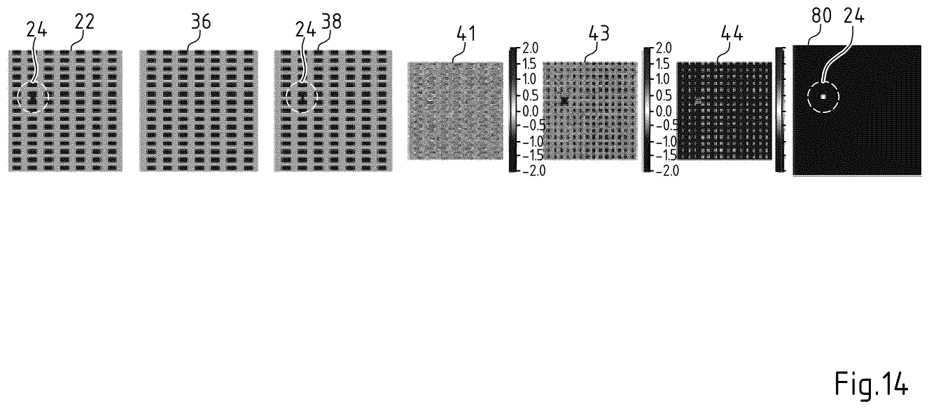

FIG. 14 illustrates the use of a joint registration and defect detection machine learning model for the detection of defects in objects 98 comprising integrated circuit patterns. The imaging dataset 22 comprising a defect 24 and the reference dataset 36 are pre-registered. In this case the common coordinate system corresponds to the imaging dataset coordinate system and, thus, the input transformation field 33 is zero and can be neglected. The joint registration and defect detection machine learning model 85 is applied to an input dataset comprising the imaging dataset 22 and the reference dataset 36. The joint registration and defect detection machine learning model 85 yields the transformation field pair 37, which contains only the reference transformation field 35 comprising the horizontal reference transformation field component 41 and the vertical reference transformation field component 43, and the defect detection map 80, which indicates the defect 24.

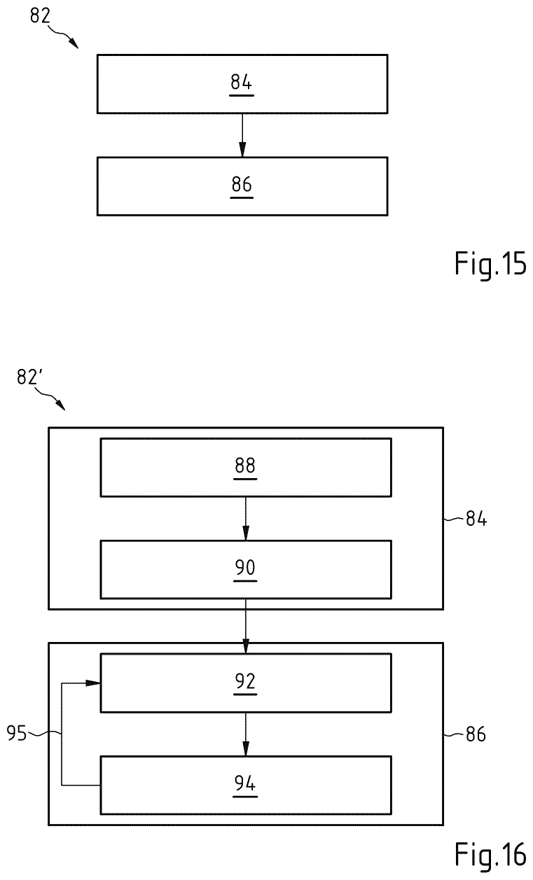

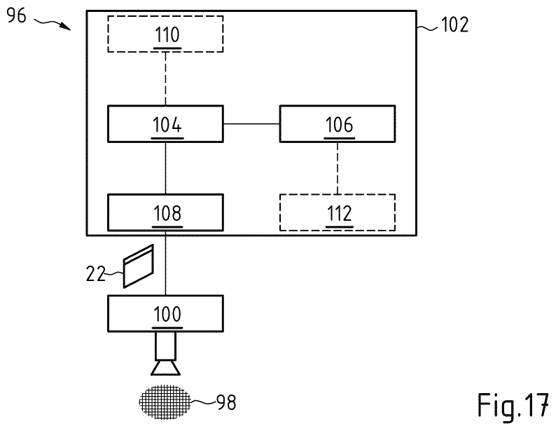

According to an example illustrated in FIG. 15, a computer implemented method for training a joint registration and defect detection machine learning model 85 for an input dataset comprising an imaging dataset 22 and a reference dataset 36 comprises: obtaining training data comprising imaging datasets 22, corresponding reference datasets 36 and corresponding defect indications in a training data generation step 84; and training the machine learning model using the obtained training data in a training step 86. The training data can optionally comprise transformation field pairs corresponding to the imaging datasets 22 and corresponding reference datasets 36. However, in order to minimize the user effort for generating the training data, a computational loss function comprising the warping error 48 can be used instead for training the registration head 81. The registration head 81 and the defect detection head 83 can be trained jointly, that means alternatingly.

An improved accuracy can be obtained if the registration head 81 and the defect detection head 83 are trained jointly. A joint training means that a single model is trained to perform multiple tasks simultaneously, in this case registration and defect detection. To this end, during a training cycle the registration head 81 and the defect detection head 83 can, for example, be trained alternatingly in order to adapt the weights to both tasks simultaneously.

Preferably, the registration head 81 and the defect detection head 83 are trained using different training datasets. Each training dataset comprises input image pairs (imaging dataset and reference dataset) and a task-specific output, together called samples. The training dataset of the registration head 81 comprises transformation fields as task-specific output, whereas the training dataset of the defect detection head 83 comprises defect indications as task-specific output. In an example, the training dataset of the registration head 81 and the training dataset of the defect detection head 83 differ in at least one of their input image pairs. One of the training datasets can, for example, comprise an input image pair which is not contained in the other training dataset. The training datasets can also have no input image pairs in common, or they can have some input image pairs in common and differ in some input image pairs, or the input image pairs of one training dataset can be a subset of the input image pairs of the other training dataset. In particular, the training dataset for the defect detection head 83 can comprise less samples than the training dataset for the registration head 81, since defect indications require considerable user effort. The training dataset for the defect detection head 83 can comprise some of the defect-free samples of the training data for the registration head 81. In this way, each head can be trained using specifically adapted training data, for example, the registration head 81 is preferably trained using defect-free input image pairs, whereas the defect detection head 83 is preferably trained using defective input image pairs.

To increase the number of samples of the training dataset for the defect detection head 83 and/or for the registration head 81 simulated samples can be used. Alternatively, only simulated samples can be used as training dataset for the defect detection head 83 and/or for the registration head 81.

According to an example illustrated in FIG. 16, a computer implemented method 82′ for training a joint registration and defect detection machine learning model 85 for an input dataset comprising an imaging dataset 22 and a reference dataset 36, the joint registration and defect detection machine learning model comprising a registration head 81 and a defect detection head 83, comprises: obtaining a registration training dataset comprising predominantly defect-free imaging datasets 22 and corresponding reference datasets 36 in a registration training data generation step 88; obtaining a defect detection training dataset comprising imaging datasets 22 including defects 24, corresponding reference datasets 36 and corresponding defect indications in a defect detection training data generation step 90; training the registration head 81 together with the joint part of the machine learning model using the registration training dataset in a registration training step 92; training the defect detection head 83 together with the joint part of the machine learning model using the defect detection training dataset in a defect detection training step 94. Thus, in this case the training data generation step 84 in FIG. 15 comprises the registration training data generation step 88 and the defect detection training data generation step 90. The training step 86 in FIG. 15 comprises the registration training step 92 and the defect detection training step 94, which are jointly trained in iterations 95. By jointly training the registration head 81 and the defect detection head 83 using different training datasets, the accuracy of the machine learning model predictions can be improved and the training time reduced. The registration head 81 is trained using predominantly defect-free imaging datasets 22 and corresponding reference datasets 36. As predominantly defect-free transformation field pairs 37 are often not available in large numbers for training, a computational loss function can be used, which can comprise the warping error 48. In this way, the user effort for providing the training data is reduced. Alternatively, predominantly defect-free transformation field pairs 37 can be used for training. Since the registration training data comprises none or very few defects 24, it is not suitable for training the defect detection head 83 of the joint registration and defect detection machine learning model 85, since the classes are heavily imbalanced. To avoid class imbalancing, the defect detection head 83 is trained on a different training dataset comprising imaging datasets 22 including defects 24 and corresponding reference datasets 36 together with defect indications. Since both heads share a common part of the model, they mutually benefit from the information learned by the other head. Thus, overfitting is prevented. The registration head 81 and the defect detection head 83 can also be arranged in a sequential fashion, such that the output of the registration head 81 is the input of the defect detection head 83.

In an example, the machine learning model is trained on more than two different training datasets, e.g., training datasets recorded on different machines or in different ways. For example, the machine learning model can be trained with simulated data, with collected in-house machine data and with on-site machine data. In this way, the generation of training data is simplified.

Any of the machine learning models used herein can be trained from scratch using training data. Alternatively, a trained machine learning model can be loaded from memory. Alternatively, a trained machine learning model can be loaded from a cloud storage. To simplify training, a pre-trained machine learning model can be loaded and adapted in a training using training data.

FIG. 16 schematically illustrates a system 96, which can be used for inspecting an object 98 comprising integrated circuit patterns for defects 24. The system 96 includes an imaging device 100 and a processing device 102. The imaging device 100 is coupled to the processing device 102, e.g., via cable or wireless. They can be located in the same room, in the same lab, in the same fab or in different buildings. The imaging device 100 is configured to acquire imaging datasets 22 of the object 98. An example implementation of the imaging device 100 would be a SEM, a Helium ion microscope (HIM), a crossbeam device including FIB and SEM or any charged particle imaging device. In another example, an aerial image measurement system is used for obtaining the imaging dataset 22. An aerial image is the radiation intensity distribution at substrate level.

The imaging device 100 can provide an imaging dataset 22 to the processing device 102. The processing device 102 includes a processor 104, e.g., implemented as a CPU or GPU. The processor 104 can receive the imaging dataset 22 via an interface 108. The processor 104 can load program code from a memory 106. The processor 104 can execute the program code. Upon executing the program code, the processor 104 performs techniques such as described herein, e.g., detecting defects 24 in an object 98 comprising integrated circuit patterns, training a machine learning model for registration, defect detection or joint registration and defect detection, training or applying a probabilistic generative model, estimating distributions or statistics or confidence intervals or regions, etc. For example, the processor 104 can perform the computer implemented method shown in FIG. 4, FIG. 10, FIG. 14 or FIG. 15 respectively upon loading program code from the memory 106. The processing device 102 can optionally contain a user interface 110 and/or a database 112. The database 112 can, for example, be used to load reference datasets 36 (acquired or simulated), training data or pre-trained machine learning models.

The methods disclosed herein can, for example, be used during research and development of objects 98 comprising integrated circuit patterns or during high volume manufacturing of objects 98 comprising integrated circuit patterns, or for process window qualification or enhancement. In addition, the methods disclosed herein can also be used for defect detection of X-ray imaging datasets of objects 98 comprising integrated circuit patterns, e.g., after packaging the semiconductor device for delivery.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment,” “according to an example” or “according to an aspect” in various places throughout this specification are not necessarily all referring to the same embodiment, example or aspect, but may refer to different embodiments, examples, or aspects. Furthermore, the particular features or characteristics may be combined in any suitable manner, as would be apparent to one of ordinary skill in the art from this disclosure, in one or more embodiments.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

The following clauses contain preferred embodiments of the invention:
1. A computer implemented method 26 for defect detection comprising:
   Obtaining an imaging dataset 22 of an object 98 comprising integrated circuit patterns;
   Obtaining a reference dataset 36 of the object 98;
   Registering the imaging dataset 22 and the reference dataset 36 by obtaining at least one transformation field pair 37 comprising an input transformation field 33 and a corresponding reference transformation field 35, the input transformation field 33 indicating the transformation of the imaging dataset 22 into a common coordinate system, and the reference dataset 36 indicating the transformation of the reference dataset into the common coordinate system, wherein the input transformation field 33 or the reference transformation field 35 can be zero; and
   Detecting defects in the imaging dataset 22 using the at least one obtained transformation field pair 37.
2. The method of clause 1, wherein the common coordinate system corresponds to a coordinate system of the imaging dataset 22 such that the input transformation field 33 of the at least one obtained transformation field pair 37 is zero, or wherein the common coordinate system corresponds to a coordinate system of the reference dataset 36 such that the reference transformation field 35 of the at least one obtained transformation field pair 37 is zero.
3. The method of any one of the preceding clauses, wherein the imaging dataset 22 and the reference dataset 36 of the at least one obtained transformation field pair 37 are pre-registered.
4. The method of any one of the preceding clauses, wherein at least one transformation field pair 37 is obtained by a registration method comprising the application of a machine learning model to an input dataset comprising the imaging dataset 22 and the reference dataset 36, the machine learning model being trained on training data comprising predominantly defect-free imaging datasets 22 and corresponding reference datasets 36.
5. The method of clause 4, wherein the machine learning model comprises a deep learning model.
6. The method of any one of the preceding clauses, wherein detecting defects 24 in the imaging dataset 22 comprises measuring the warping error 48 of the imaging dataset 22 warped according to the input transformation field 33 and the reference dataset 36 warped according to the reference transformation field 35 of the at least one obtained transformation field pair 37.
7. The method of clause 6, wherein detecting defects 24 in the imaging dataset 22 comprises applying a machine learning model for defect detection to the warping error 48, the machine learning model being trained on training data comprising warping errors 48 of imaging datasets 22 warped according to input transformation fields 33 and corresponding reference datasets 36 warped according to the corresponding reference transformation fields 35 of transformation field pairs 37 and corresponding defect indications.
8. The method of any one of the preceding clauses, wherein detecting defects 24 in the imaging dataset 22 comprises measuring a property of spatial subsets of the input transformation field 33 and/or of spatial subsets of the reference transformation field 35 of the at least one obtained transformation field pair 37 and defining one or more thresholds for the measured property.
9. The method of any one of the preceding clauses, wherein detecting defects 24 in the imaging dataset 22 comprises applying a machine learning model for defect detection to the at least one obtained transformation field pair 37, the machine learning model being trained on training data comprising transformation field pairs 37 and corresponding defect indications.
10. The method of any one of the preceding clauses, wherein detecting defects in the imaging dataset 22 comprises estimating a distribution of spatial subsets of one or more transformation field pairs 37, and wherein defects 24 in the imaging dataset 22 are detected using the at least one obtained transformation field pair 37 and the estimated distribution.
11. The method of clause 10, wherein detecting defects 24 in the imaging dataset 22 comprises estimating a confidence interval or a confidence region of the estimated distribution.
12. The method of any one of the preceding clauses, wherein multiple transformation field pairs registering the imaging dataset 22 and the reference dataset 36 are obtained, and wherein detecting defects 24 in the imaging dataset 22 comprises measuring a variation of the multiple obtained transformation field pairs 37.
13. The method of clause 12, wherein obtaining each of the multiple transformation field pairs 37 comprises applying a different registration method to the imaging dataset 22 and the reference dataset 36.
14. The method of clause 12 or 13, wherein obtaining each of the multiple transformation field pairs 37 comprises applying random perturbations to the imaging dataset 22 and/or to the reference dataset 36 and/or to parameters of the registration method.
15. The method of any one of clauses 12 to 14, wherein obtaining the multiple transformation field pairs 37 comprises using a probabilistic generative model, the probabilistic generative model being trained on predominantly defect-free training data.
16. The method of any one of clauses 12 to 15, wherein obtaining the multiple transformation field pairs 37 comprises using a probabilistic generative image transformation model, which transforms one or more input images to a distribution over output images, wherein the one or more input images and the output images have the same dimension.
17. The method of clause 15 or 16, wherein the probabilistic generative model is a variational autoencoder or a conditional generative adversarial network.
18. The method of any one of clauses 12 to 17, wherein measuring the variation of the multiple obtained transformation field pairs 37 comprises estimating a distribution of a spatial subset of the multiple obtained transformation field pairs 37.
19. The method of clause 18, wherein detecting defects 24 in the imaging dataset 22 comprises estimating one or more moments of the estimated distribution.
20. The method of clause 18, wherein detecting defects 24 in the imaging dataset 22 comprises generating a transformation field pair registering the imaging dataset 22 and the reference dataset 36, estimating a confidence interval or a confidence region of the estimated distribution and evaluating the likelihood of the corresponding spatial subset of the generated transformation field pair for being an outlier with respect to the estimated distribution.
21. The method of any one of clauses 1 to 5, wherein detecting defects 24 in the imaging dataset 22 comprises applying a joint registration and defect detection machine learning model to an input dataset comprising the imaging dataset 22 and the reference dataset 36, the machine learning model computing a transformation field pair 37 and a defect detection in the imaging dataset 22, the transformation field pair 37 registering the imaging dataset 22 and the reference dataset 36.
22. The method of clause 21, wherein the joint registration and defect detection machine learning model comprises a registration head 81 and a defect detection head 83, which are trained jointly using different training datasets.
23. Computer-readable medium, having stored thereon a computer program executable by a computing device, the computer program comprising code for executing a method of any one of the preceding clauses.
24. Computer program product comprising instructions which, when the program is executed by a computer, cause the computer to carry out a method of any one of the preceding method clauses.
25. System 96 for detecting defects 24 comprising:
   an imaging device 100 configured to provide an imaging dataset 22 of an object 98 comprising integrated circuit patterns;
   one or more processing devices 102;
   one or more machine-readable hardware storage devices comprising instructions that are executable by one or more processing devices 102 to perform operations comprising any one of the methods the preceding clauses.

In summary, the invention relates to a computer implemented method 26 for defect detection comprising: obtaining an imaging dataset 22 of an object 98 comprising integrated circuit patterns; obtaining a reference dataset 36 of the object 98; registering the imaging dataset 22 and the reference dataset 36 by obtaining at least one transformation field pair 37 comprising an input transformation field 33 and a corresponding reference transformation field 35, the input transformation field 33 indicating the transformation of the imaging dataset 22 into a common coordinate system, and the reference transformation field 35 indicating the transformation of the reference dataset into the common coordinate system, wherein the input transformation field 33 or the reference transformation field 35 can be zero; and detecting defects in the imaging dataset 22 using the at least one obtained transformation field pair 37. The invention also relates to a computer-readable medium, a computer program product and a system 96 for detecting defects 24.

### REFERENCE NUMBER LIST

10, 10′ Photolithography system
12 Radiation source
14 Photolithography mask
16 Illumination optics
18 Projection optics
20 Wafer
22 Imaging dataset
24 Defect
26 Computer implemented method
28 Imaging step
30 Reference step
31 Common coordinate system
32 Registration step
33 Input transformation field
34 Defect detection step
35 Reference transformation field
36 Reference dataset
37 Transformation field pair
38 Warped imaging dataset
40 Horizontal input transformation field component
41 Horizontal reference transformation field component
42 Vertical input transformation field component
43 Vertical reference transformation field component
44 Norm
46 Difference image
48 Warping error
50 Segmentation map
52 Bounding boxes
54 Defect detection
55 Computer implemented method
56 Detection rates
57 Training data generation step
58 Defect dataset
59 Training step
60 Observation space
62 Stochastic encoder
64 Latent space
65 Latent posterior distribution
66 Stochastic decoder
68 Observation posterior distribution
70 Horizontal MMSE estimate
72 Vertical MMSE estimate
74 Horizontal standard deviation
75 Layers
76 Vertical standard deviation
77 Bottleneck
78 Features
79 Arrow
80 Defect detection map
81 Registration head
82, 82′ Computer implemented method
83 Defect detection head
84 Training data generation step
85 Joint registration and defect detection machine learning model
86 Training step
88 Registration training data generation step
90 Defect detection training data generation step
92 Registration training step
94 Defect detection training step
95 Iteration
96 System
98 Object
100 Imaging device
102 Processing device
104 Processor
106 Memory
108 Interface
110 User interface
112 Database

1. A computer implemented method for defect detection comprising:
obtaining an imaging dataset of an object comprising integrated circuit patterns;
obtaining a reference dataset of the object;
registering the imaging dataset and the reference dataset by obtaining at least one transformation field pair comprising an input transformation field and a corresponding reference transformation field, the input transformation field indicating the transformation of the imaging dataset into a common coordinate system, and the reference transformation field indicating the transformation of the reference dataset into the common coordinate system, wherein the input transformation field or the reference transformation field can be zero; and
detecting defects in the imaging dataset using the at least one obtained transformation field pair.

2. The method of claim 1, wherein the common coordinate system corresponds to a coordinate system of the imaging dataset such that the input transformation field of the at least one obtained transformation field pair is zero, or wherein the common coordinate system corresponds to a coordinate system of the reference dataset such that the reference transformation field of the at least one obtained transformation field pair is zero.

3. The method of claim 1, wherein the imaging dataset and the reference dataset of the at least one obtained transformation field pair are pre-registered.

4. The method of claim 1, wherein at least one transformation field pair is obtained by a registration method comprising a trained machine learning model that maps an input dataset comprising the imaging dataset and the reference dataset to a transformation field pair.

5. The method of claim 4, wherein the machine learning model comprises a deep learning model.

6. The method of claim 1, wherein detecting defects in the imaging dataset comprises measuring warping error of the imaging dataset warped according to the input transformation field and the reference dataset warped according to the reference transformation field of the at least one obtained transformation field pair.

7. The method of claim 6, wherein detecting defects in the imaging dataset comprises applying a trained machine learning model for defect detection to the warping error.

8. The method of claim 1, wherein detecting defects in the imaging dataset comprises measuring a property of spatial subsets of the input transformation field and/or of spatial subsets of the reference transformation field of the at least one obtained transformation field pair.

9. The method of claim 1, wherein detecting defects in the imaging dataset comprises applying a trained machine learning model for defect detection to the at least one obtained transformation field pair.

10. The method of claim 1, wherein detecting defects in the imaging dataset comprises estimating a distribution of spatial subsets of one or more transformation field pairs, and wherein defects in the imaging dataset are detected using the at least one obtained transformation field pair and the estimated distribution.

11. The method of claim 10, wherein detecting defects in the imaging dataset comprises estimating a confidence interval or a confidence region of the estimated distribution.

12. The method of claim 1, wherein multiple transformation field pairs registering the imaging dataset and the reference dataset are obtained, and wherein detecting defects in the imaging dataset comprises measuring a variation of the multiple obtained transformation field pairs.

13. The method of claim 12, wherein obtaining each of the multiple transformation field pairs comprises applying a different registration method to the imaging dataset and the reference dataset.

14. The method of claim 12, wherein obtaining each of the multiple transformation field pairs comprises applying random perturbations to the imaging dataset and/or to the reference dataset and/or to parameters of the registration method.

15. The method of claim 12, wherein obtaining the multiple transformation field pairs comprises using a trained probabilistic generative model.

16. The method of claim 12, wherein obtaining the multiple transformation field pairs comprises using a probabilistic generative image transformation model, which transforms one or more input images to a distribution over output images, wherein the one or more input images and the output images have the same dimension.

17. The method of claim 15, wherein the probabilistic generative model is a variational autoencoder or a conditional generative adversarial network.

18. The method of claim 12, wherein measuring the variation of the multiple obtained transformation field pairs comprises estimating a distribution of a spatial subset of the multiple obtained transformation field pairs.

19. The method of claim 18, wherein detecting defects in the imaging dataset comprises estimating one or more moments of the estimated distribution.

20. The method of claim 18, wherein detecting defects in the imaging dataset comprises generating a transformation field pair registering the imaging dataset and the reference dataset, estimating a confidence interval or a confidence region of the estimated distribution and evaluating the likelihood of the corresponding spatial subset of the generated transformation field pair for being an outlier with respect to the estimated distribution.

21. The method of claim 1, wherein detecting defects in the imaging dataset comprises applying a joint registration and defect detection machine learning model to an input dataset comprising the imaging dataset and the reference dataset, the machine learning model computing a transformation field pair and a defect detection in the imaging dataset, the transformation field pair registering the imaging dataset and the reference dataset.

22. The method of claim 21, wherein the joint registration and defect detection machine learning model comprises a registration head and a defect detection head, which are trained jointly.

23. A computer-readable medium, having stored thereon a computer program executable by a computing device, the computer program comprising code for executing a method of claim 1.

24. A computer program product comprising instructions which, when the program is executed by a computer, cause the computer to carry out a method of claim 1.

25. A system for detecting defects comprising:
an imaging device configured to provide an imaging dataset of an object comprising integrated circuit patterns;
one or more processing devices; and
one or more machine-readable hardware storage devices comprising instructions that are executable by one or more processing devices to perform operations comprising a method according to claim 1.
